(19) United States
(12) Patent Application Publication
(10) Pub. No.: US 2016/0034516 A1
(43) Pub. Date: Feb. 4, 2016

(54) METHOD AND SYSTEM FOR ANALYSIS OF AN OBJECT

(71) Applicant: CORPORATE DATA DESIGN, INC., Strasburg, VA (US)

(72) Inventor: John R. Skolits, Strasburg, VA (US)

(73) Assignee: CORPORATE DATA DESIGN, INC., Strasburg, VA (US)

(21) Appl. No.: 14/445,804

(22) Filed: Jul. 29, 2014

(51) Int. Cl. G06F 17/30

(52) U.S. Cl. CPC G06F 17/30371; G06F 17/30705

(57) ABSTRACT

Methods, systems, and computer products for analyzing an object to determine contents of the object. The methods, systems, and computer products include a procedure having one or more groups that segment the object to be analyzed. One or more items are assigned to the groups, and each item includes one or more attributes that are associated with the item. Further, a predefined sequence for evaluation of the items is associated with the procedure. Each item is then displayed in accordance with the predefined sequence for evaluation of each attribute associated with the items. To this end, an attribute field associated with each attribute is presented and can be electronically interacted with in order to indicate evaluation of the attribute.

### TECHNICAL FIELD

The invention generally relates to the review and analysis of systems or objects, and in particular to a computer based analysis of an object or system to determine the contents of the object or system.

### BACKGROUND

Computer technology is increasingly used to provide tools to assist in the analysis of an object or system to determine the object's/system's contents. Such tools are commonly referred to as “checklists.” In particular, while performing analysis of an object/system, reference can be made to a list of specific items for the object/system that is displayed on a computing device. Each item in the list serves as a reminder of the necessary contents that the object/system needs and what items need attention in the analysis. In some systems, as each item is analyzed, it can be “checked off” by interacting with an appropriate computer interface.

For example, an inspector of a machine might reference a list of parts or elements of the machine that require analysis as a condition of completing the inspection. Upon inspecting one of the parts, the inspector could select the inspected part on the display, thereby marking or checking off that part as inspected. By following this procedure throughout the inspection, the inspector is able to keep track of the parts that have been inspected and those that have not, thereby assuring that no parts are inadvertently overlooked. In an alternative example, a person might inspect or inventory a workspace to determine that the workspace is stocked properly for future work. For example, used items might be replenished, or missing items might be replaced. Additionally, once the inspection is complete, a person might add one or more items to the list.

Conventional methods that utilize computer technology for analyzing an object/system and managing one or more lists offer several advantages. For example, a computing device can store many item lists for analysis of many different objects/systems, thereby allowing analysis of multiple objects/systems with little downtime in between. In addition, the mobility of computing devices allows analysis of an object/system without having to bring various papers and tools to the site of the object. Perhaps most advantageous, however, is that modern computing technology allows remote creation of lists, which can then be downloaded to a computing device located near the object/system being analyzed.

Conventional systems for analysis and list creation/management, however, fail to take into account the increasingly complex nature of the objects/systems being analyzed and the vast amount of identical objects that may require review or analysis. Many such existing systems are simply lists of items. Also with remote list creation and the mobility of computing devices, the creator of a list is often different from the person actually doing the review or analyzing the object/system, who, in turn, is often different from a person reviewing or analyzing a separate but identical object or system. As a result, analysis and checklist usage may be limited or conducted inconsistently, which can yield inefficient analyses as well as differing and inaccurate results. Thus, there exists a need to improve the overall review process, and to ensure that such review and analysis is performed accurately, uniformly, and efficiently.

### SUMMARY

In one embodiment, a method is provided for analyzing an object to determine contents of the object. The method includes defining a plurality of groups that segment the object to be analyzed and assigning one or more separate items to each group of the defined plurality of groups. In addition, the method includes associating, with each item, one or more attributes for the item. The method further includes defining a predefined sequence for evaluation of the items and attributes. Additional steps of the method include displaying the items in the predefined sequence on a device for evaluation of the items and attributes associated with each item, as well as presenting an attribute field associated with each attribute for each item, the attribute field being configured to be electronically interacted with to indicate an evaluation of the attribute.

Additional embodiments provide further features of the method. For example, at least one of the attributes for an item may be a status of the item including at least one of an OK status, a pending status, or a failed status. In addition, the method may include designating a plurality of potential exceptions relating to the failed status of the item. Further, at least one of the attributes for an item may include a value type attribute associated with the item, and at least one of the attributes may include a logic test, the logic test being configured to evaluate the value type attribute associated with the item.

In some embodiments, the method may include presenting a text field associated with one of the items, the text field configured to be electronically interacted with to provide additional information about the evaluation of at least one of the attributes of the item. In addition and/or alternatively, the method may include assigning each item to a category that is descriptive of the item, and displaying the items by category to a user to facilitate assigning the one or more items to the defined groups. Furthermore, the method may include designating an allowable input type for the attribute field associated with at least one of the attributes for an item.

In some embodiments, the method may include designating an alternate name for each item, and displaying the different names for the items on different device. In addition, the method may include generating a report of an analysis of an object, and providing the report to a recipient via a text message or an E-mail.

In another embodiment, a system is provided that includes at least one processor and a memory coupled to the processor. The memory stores instructions that, when executed by the processor, cause the system to create a procedure that defines a plurality of groups that segment the object to be analyzed; assign one or more separate items to each group of the defined plurality of groups; associate, with each item, one or more attributes for the item; define a predefined sequence for evaluation of the items and attributes, and upload the procedure to a database accessible by a computing device over a communications network. The procedure, when downloaded by the computing device over the communications network, causes the computing device to display the items in the predefined sequence on the device for evaluation of the items and the attributes associated with each item, and present an attribute field associated with each attribute for each item, the attribute field being configured to be electronically interacted with to indicate an evaluation of the attribute.

Additional embodiments provide further features of the system. For example, at least one of the attributes for an item may be a status of the item including at least one of an OK status, a pending status, or a failed status. The instructions may further cause the system to designate a plurality of potential exceptions relating to the failed status of the item. At least one of the attributes may further include a value type associated with the item. In addition, at least one of the attributes may include a logic test configured to evaluate the value type attribute associated with the item

In additional embodiments, the computer device may present, in response to a user input, a text field associated with one of the items, the text field configured to be electronically interacted with to provide additional information about an evaluation of at least one of the attributes of the item. The instructions may further cause the system to assign each item to a category descriptive of the item, and display the items by category to facilitate assigning the items to the groups. The instructions may further cause the system to designate an allowable input for the attribute field associated with at least one of the attributes for an item. In addition, the instructions may further cause the system to generate a report of an analysis of an object, and provide the report to a recipient via a text message or an E-mail.

In another embodiment, a computer program product is provided that includes a non-transitory computer readable storage medium having program code stored thereon. The program code is configured, upon execution by at least one processor, to cause the processor to create a procedure that defines a plurality of groups that segment the object to be analyzed; assign one or more separate items to each group of the defined plurality of groups; associate, with each item, one or more attributes for the item; associate with the procedure a predefined sequence for evaluation of the items and attributes; and upload the procedure to a database accessible by a computing device over a communications network. The procedure, when downloaded by the computing device over the communications network, causes the computing device to display the items in the predefined sequence on the device for evaluation of the items and the attributes associated with each item, and present an attribute field associated with each attribute for each item, the attribute field being configured to be electronically interacted with to indicate an evaluation of the attribute.

### BRIEF DESCRIPTION OF THE DRAWINGS

The accompanying drawings, which are incorporated in and constitute a part of this specification, illustrate embodiments of the invention and, together with a general description of the invention given below, serve to explain the principles of the invention.

FIG. 1 is a schematic view a system in accordance with one or more embodiments of the invention.

FIG. 2 is a schematic view of a computer device or system implemented in accordance with one or more embodiments of the invention.

FIG. 3 is a schematic view of applications and databases implemented in accordance with one or more embodiments of the invention.

FIG. 4 is a schematic view of exemplary databases in accordance with one or more embodiments of the invention.

FIG. 5 is a flowchart illustrating features of an embodiment of the invention.

FIG. 6 is a view of an exemplary interface implemented in an embodiment of the invention.

FIG. 7 is a view of another exemplary interface implemented in an embodiment of the invention.

FIG. 8 is a view of another exemplary interface implemented in an embodiment of the invention.

FIG. 9 is a view of another exemplary interface implemented in an embodiment of the invention.

FIG. 10 is a view of another exemplary interface implemented in an embodiment of the invention.

FIG. 11 is a view of another exemplary interface implemented in an embodiment of the invention.

FIG. 12 is a view of another exemplary interface implemented in an embodiment of the invention.

FIG. 13 is a view of another exemplary interface implemented in an embodiment of the invention.

FIG. 14 is a flowchart illustrating features of an embodiment of the invention.

FIG. 15 is a view of another exemplary interface in accordance with an embodiment of the invention.

FIG. 16 is a view of another exemplary interface in accordance with an embodiment of the invention.

FIG. 17 is a view of another exemplary interface in accordance with an embodiment of the invention.

FIGS. 18A-18C are views of additional exemplary interfaces implemented in an embodiment of the invention.

FIG. 19 is a view of another exemplary interface implemented in an embodiment of the invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

Some embodiments of the invention generally relate to methods, systems, and/or computer products for reviewing and analyzing an object or system to determine its contents, and to ensure that such contents are in good order and/or are complete. In a particular embodiment, a checklist in the form of a checkoff procedure is implemented for a user to analyze or review an object or system. Hereinafter, such objects/systems being evaluated will be referred to as an “object” without limiting what object, system, methodology, task, or other thing is being reviewed or evaluated. A computer device/system is configured to create a procedure for analyzing an object to determine the object's contents. In general, analyzing an object to determine the object's contents may include evaluating the list of contents for the object, as well as attributes of certain objects. Accordingly, the created procedure is designed to streamline the evaluation of the contents of the object, and to that end, may include a particular configuration and/or a predetermined sequence by which the contents of the object should be evaluated. The checkoff procedure or list may be created and downloaded to another computing device, such as a mobile device, which displays the contents of the object according to the configuration and/or predetermined sequence of the downloaded checkoff procedure. A user may then interact with the mobile device and input data while performing the analysis of the object. The mobile device, pursuant to the downloaded procedure, may both guide the user during the analysis and record or check off the user's evaluations of the individual contents of the object.

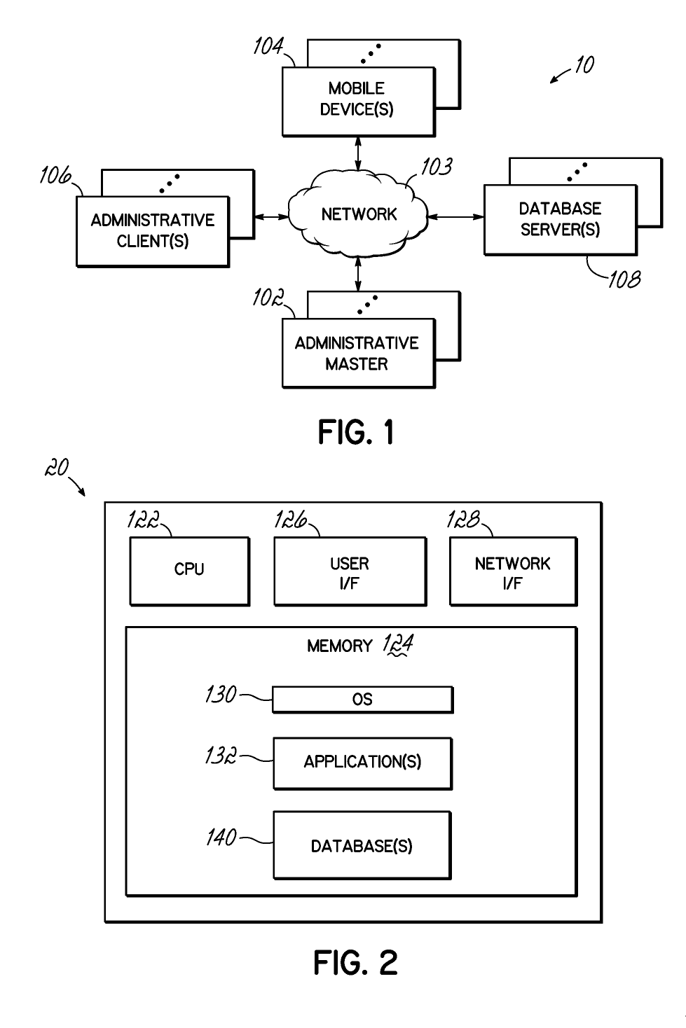

Turning now to the Figures, wherein like numbers denote like parts through the several views, FIG. 1 provides a schematic diagram illustrating an operating environment or system 10 consistent with one or more embodiments of the invention. As shown in FIG. 1, an administrative master 102 may be connected to a suitable communication network 103 for interfacing with the various other elements. The communication network 103 may comprise the Internet, a local area network (LAN), a wide area network (WAN), a cellular voice/data network, one or more high speed connections, and/or other such types of communication networks, or combinations of networks. One or more mobile devices 104, one or more administrative clients 106, and/or one or more database servers 108 are also appropriately connected to the communication network 103 such that the mobile devices 104, the administrative clients 106, and/or database servers 108 may each communicate data to and from the administrative master 102 and/or to and from each other. In general, a mobile device 104, an administrative client 106, the administrative master 102, and/or the database server 108 may be implemented appropriately as a suitable processing device, such as a cellular phone or smart phone, tablet computer, laptop computer, a desktop computer, thin client terminal, server device, or server, and/or other such computing device, but none are limited to such devices. Additionally, the database servers 108, administrative clients 106, mobile devices 104, and/or administrative master 102 may be cloud-based computer devices.

In general, the administrative master 102 may be used by an administrator or other user, and is configured to create, update, and/or delete procedures for analyzing an object to determine the object's contents, such procedures being stored in the database server 108. Each procedure may be configured to assist a user or evaluator while analyzing a particular object. To this end, the mobile devices 104 may be used by users or evaluators and are generally configured to download one or more of the procedures from the database server 108, and thereafter generate the appropriate user interfaces based on the retrieved procedure. The generated interfaces are designed to assist a user or evaluator while analyzing the object corresponding to the downloaded procedure, as well as record the user's/evaluator's observations and other data. Once the analysis has been completed, the mobile device 104 may further be configured to upload the results of the analysis to database server 108 to be stored. Upon receiving and storing the results, the database server 108 may be configured to communicate a report based on the received results to one or more designated recipients, as specified in the particular procedure corresponding to the results.

Each procedure that is created in accordance with the invention and stored in a database server 108 generally comprises data relating to instructions for analyzing an object to determine the object's contents. In general, the data of each procedure may comprise one or more groups that segment the object to be analyzed into one or more different aspects of the object. Each group may itself include one or more items that represent the “contents” of the object being analyzed, and each item may have one or more attributes associated therewith that are to be evaluated during the analysis. Moreover, the data of each procedure may include a predetermined sequence by which the items and groups should be evaluated during the analysis. Such a predetermined sequence helps ensure that analyses of objects of the same kind are uniform and consistent, regardless of the user/evaluator who is performing the analysis or when they are performing it. In addition, the predetermined sequence helps guide a user during the analysis, thereby increasing speed, accuracy and lessening the importance of an individual user's/evaluator's expertise and experience at the task.

As applied herein, the term “object” may include any system, equipment, document, product, article of manufacture, inanimate object, animate object, and/or any other object suitable for use in accordance with the one or more embodiments of the present invention. For example, the object may be a machine. Examples of a machine may include, without limitation, a computing device, electronics, manufacturing equipment, appliances, and/or a moving vehicle, which may further include, for example and without limitation, an ambulance, helicopter, police cruiser, construction equipment, fire truck, airplane, and/or other like equipment. In one particular example, as discussed in detail herein to illustrate an embodiment of the invention, the object is an ambulance vehicle that must be maintained and properly stocked for each use. Alternatively, the object may be a structure. Examples of structures, without limitation, include a home, room, operating facility, work area, business, playground, exercise equipment, furniture, and/or other like buildings or structures. In yet another exemplary embodiment, the object may be a document, whether electronic, handwritten, or otherwise. In other exemplary embodiments, the object may be a living organism, such as a human being or animal. An object may also include any combination and/or component of the above mentioned examples. It can be appreciated that an object may be any thing or system that would be recognized by those of ordinary skill in the art as suitable for analysis in accordance with the embodiments of the invention. In addition, it can be appreciated that various aspects of the present embodiments may be readily adapted, configured, and/or structured for applicably to a wide variety and plurality of different objects.

As applied herein, “contents” of an object includes any aspect of the object and/or items or components thereof that can be evaluated individually, or as a collection, according to the one or more embodiments of the present invention. For example and without limitation, determining the contents of an object may include evaluating the object itself, as well as any item within and/or associated with the object. In the exemplary embodiment where the object to be analyzed is an ambulance, determining the ambulance's contents may include, without limitation, evaluating the ambulance's engine, wipers/washers, heater/defroster, vehicle registration, and/or insurance. In addition, determining the ambulance's contents may include evaluating one or more external or internal compartments, and/or any items within the external or internal compartments, including, but not limited to, throw bags, a wrench, a tool bag, triangles, caution tape, bolt cutters, sheers, a hand saw, a TNT power unit, hoses, a combi tool, a ram, a flat head axe, and/or medical items including backboards, reeves, a scoop stretcher, rapid stairs, 4×4s, wedges, a defibrillator, a suction, pharmaceuticals, bandages, and/or any other like items, equipment, or devices. Furthermore, determining the ambulance's contents may include evaluating the paramedics and/or drivers assigned to the ambulance. It can be appreciated that the above described contents are exemplary only, and the various aspects of the embodiments of the invention may be readily adapted, configured, and/or structured for applicability to a wide variety and plurality of different contents that are within and/or associated with a given object.

In a preferred embodiment, an administrative master device 102 must be implemented before any mobile devices 104 or administrative clients 106 associated with the administrative master 102 are implemented. In one embodiment, when implementing an administrative master device 102 for the first time, the user performing the installation must enter a customer number (or “CFICode”), which is associated with the particular customer who has purchased the administrative master 102, the software for installing the administrative master 102, or otherwise has control over or access to the administrative master 102. Once implemented, the administrative master 102 is configured to generate a unique administrative passcode based on, for example, the hard drive ID and MAC address of the administrative master 102. This unique administrative passcode is thereafter required when installing and/or registering a new administrative client 106 and/or a new mobile device 104 associated with the administrative master 102, thereby granting the new administrative client 106 and/or mobile device 104 authorization to access a database server 108 and all or some of the procedures managed by the administrative master 102. Similarly, each time an administrative client 106 and/or mobile device 104 is installed, a unique client passcode may be generated based on the components of the device, such as the device's hard drive ID and/or MAC address. Once fully implemented, the administrative master 102, the administrative clients 106, and/or the mobile devices 104 each store internally the associated unique administrative passcode and/or customer number so that the passcode or number does not need to be entered for any subsequent use of the devices. In addition, each of the administrative clients 106 and/or mobile devices 104 has the client passcode generated by that device internally stored. In some embodiments, the administrative master 102 and/or administrative client 106 is aware of each of the client passcodes and the devices associated therewith. To that end, as is further described below, the client passcodes, administrative passcodes, and/or customer numbers may facilitate access to procedures created by the administrative master 102 or administrative client 106, and/or be transmitted with results data of an analysis to facilitate organizing the results received from each of the mobile devices 104.

In general, the administrative clients 106 may have all of the same features as the administrative master 102, except that an administrative client 106 is not configured to generate a unique administrative passcode. Nevertheless, because an administrative client 106 may have almost all of the same features as the administrative master 102, the administrative client 106 may be considered a satellite version of the administrative master 102. In a preferred embodiment, there are only one administrative master 102 and a plurality of administrative clients 106.

In general, database server 108 may be configured to store and maintain a database of procedures in accordance with data received from the administrative master 102. In addition, the database server 108 may be configured to store and maintain a database of results in accordance with data received from mobile devices 104. The database server 108 may also be configured to communicate a report based on the received results to one or more designated recipients, as specified in the procedure corresponding to the results on which the report is based.

Referring now to FIG. 2, the administrative master 102, the mobile devices 104, the administrative clients 106, and/or the database server 108 of operating environment 10 may be implemented on one or more computer devices or systems, such as exemplary computer system 20. The computer system 20 may include at least one processor 122, having at least one hardware-based microprocessor, and a memory 124 coupled to the at least one processor 122. The processor 122 may include one or more devices selected from microprocessors, micro-controllers, digital signal processors, microcomputers, central processing units, field programmable gate arrays, programmable logic devices, state machines, logic circuits, analog circuits, digital circuits, and/or any other devices that manipulate signals (analog or digital) based on operational instructions that are stored in the memory 124. The memory 124 may represent a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, and/or any other device capable of storing information. In addition, memory 124 may be considered to include memory storage physically located elsewhere in computer system 20 (e.g., any cache memory in a microprocessor), as well as any storage capacity used as virtual memory. Furthermore, memory 124 may be considered to include memory storage located physically remote from and accessible to computer system 20, such as storage devices of other computer systems coupled to the computer system 20 and/or one or more mass storage devices, which may be, for example, external hard disk storage devices, external databases, storage area network devices, and/or any other mass storage device that would be recognized as suitable by those skilled in the art.

For interface with a user or operator, the computer system 20 may include a user interface 126 incorporating one or more user input/output devices. For example, the computer system 20 could incorporate a keyboard, a mouse or other pointing device, a display, a printer, a microphone, a speaker, a touch screen, and/or any other input/output device that those skilled in the art would recognize as suitable for communicating or interfacing with a user. Data may be communicated by computer system 20 to and/or from another device, computer, or terminal over a suitable network interface 128 that is coupled to the communication network 103 (FIG. 1).

The computer system 20 typically operates under the control of an operating system 130 and executes or otherwise relies upon various computer software applications, sequence of operations, components, programs, files, objects, modules engines, or any like applications, such as application 132. In specific embodiments, computer system 20 may execute or otherwise rely on an administrative application, an evaluation application, and/or a communication application, which are discussed in more detail below. In an alternative embodiment, the processor 122 may execute application 132 directly, in which case the operating system 130 may be omitted.

In one embodiment, the applications 132 may be implemented as one or more downloadable applications, such as an application supported by Android and iOS operating systems available from Open Handset Alliance and Apple computer, respectively, or in other forms of program code as appropriate for a particular computer device or system. In some embodiments, the applications 132 may be downloaded from an external source including, for example, a network accessible location (e.g., a mobile application store, an accessible database, etc.), a computer readable storage media, and/or other such external sources.

The memory 124 of computer system 20 may generally store one or more databases 140 including, for example, a procedure database that may store one or more procedures for analyzing an object and/or a results database that may store the results of analyzing an object according to one of the procedures. These exemplary databases are discussed in more detail below.

The one or more databases 140 may comprise data and supporting data structures that store and organize the data used by the invention, including data from the administrative master 102, mobile devices 104, and/or administrative clients 106. In particular, the databases 140 may be arranged with any database organization and/or structure including, but not limited to, a relational database, a hierarchical database, a network database, and/or combinations thereof. A database management system in the form of a computer software application executing as instructions on a processing unit of the computer system 20 may be used to access the information or data stored in the databases 140 in response to a query, where a query may be dynamically determined and executed by the operating system 130 and/or other applications 132.

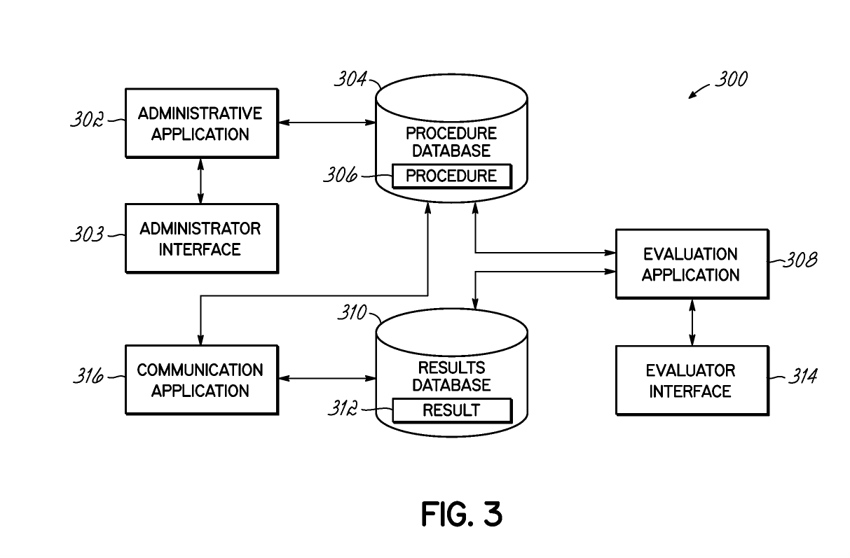

Referring to FIG. 3, various applications 132 and databases 140 consistent with embodiments of the invention will now be described. To begin, an administrative application 302 run by the administrative master may be operatively coupled to a procedure database 304, which may be configured to store one or more procedures 306 for analyzing an object to determine the object's contents in accordance with the invention. The procedure database 304 may be hosted by the database server 108 (FIG. 1).

Administrative application 302 may be hosted by the administrative master 102 and/or the administrative clients 106 (FIG. 1). Moreover, the administrative application 302 may be configured, upon being executed by a processor 122, to perform the above described functions of the administrative master 102 and/or the administrative clients 106. Accordingly, administrative application 302 may be configured to create new procedures 306 and upload the same to be stored on the procedure database 304, retrieve, edit, and update existing procedures 306 on procedure database 304, and/or delete procedures 306 from procedure database 304.

In addition, administrative application 302 may be configured to generate an administrator interface 303 by which a user/administrator may input information, such as by the user interface 126 of computer system 20, into the administrative application 302 and/or the administrative master 102. Typically, the administrator interface 303 may be accessible by input/output devices coupled with the administrative master 102 and the administrative application 302. However, in some embodiments, administrator interface 303 may be a web-based user interface, and the user may access the web-based user interface with an Internet web browser. In other embodiments, the administrator interface 303 may be a dedicated interface, such as an interface that may be provided by a special purpose application configured to be executed on a computer device and receive interface data from the administrative application 302.

An evaluation application 308 is operatively coupled to procedure database 304 and results database 310, the latter of which may be configured to store one or more results 312 from analyzing an object pursuant to a corresponding procedure 306. Evaluation application 308 may be hosted by the mobile devices 104 (FIG. 1) and may be configured, upon execution by a processor 122, to implement the herein described functions of a mobile device 104. Accordingly, evaluation application 308 may be configured to download a procedure 306 from the procedure database 304 and generate an interface based on the downloaded procedure, which a user may interact with while analyzing a corresponding object.

To that end, evaluation application 308 may also be configured to generate an appropriate evaluator interface 314, as noted herein, based on a downloaded procedure 306. In general, a user/evaluator may use the evaluator interface 314 to input information and data to the evaluation application 308 and/or mobile device 104 (FIG. 1) such as by the user interface 126 of computer system 20. The input information may generally relate to the user's observations while analyzing or “checking off” an object corresponding to the downloaded procedure 306. Typically, the evaluator interface 314 may be accessible through input/output devices or device features running the evaluation application 308 and/or mobile device 104. However, in alternative embodiments, the evaluator interface 314 may be accessible through an Internet web browser, dedicated interface, or any other gateway that would be recognized as suitable by those skilled in the art.

After an object has been analyzed according to a downloaded procedure 306, evaluation application 308 may be configured to upload the results 312 of the analysis to a results database 310 to be stored therein. The results database 310 may also be hosted on the database server 108.

In addition, a communication application 316 may be operatively coupled to the results database 310 and/or procedure database 304. The communication application 316 may also be hosted on the database server 108. Similar to the other applications, the communication application 316 may be configured, upon being executed by a processor 122, to perform the functions of the database server 108. Accordingly, the communication application 316 may be configured to transmit a report based on received results 312 to one or more designated recipients, as specified in the procedure 306 corresponding to the results 312 on which the report is based.

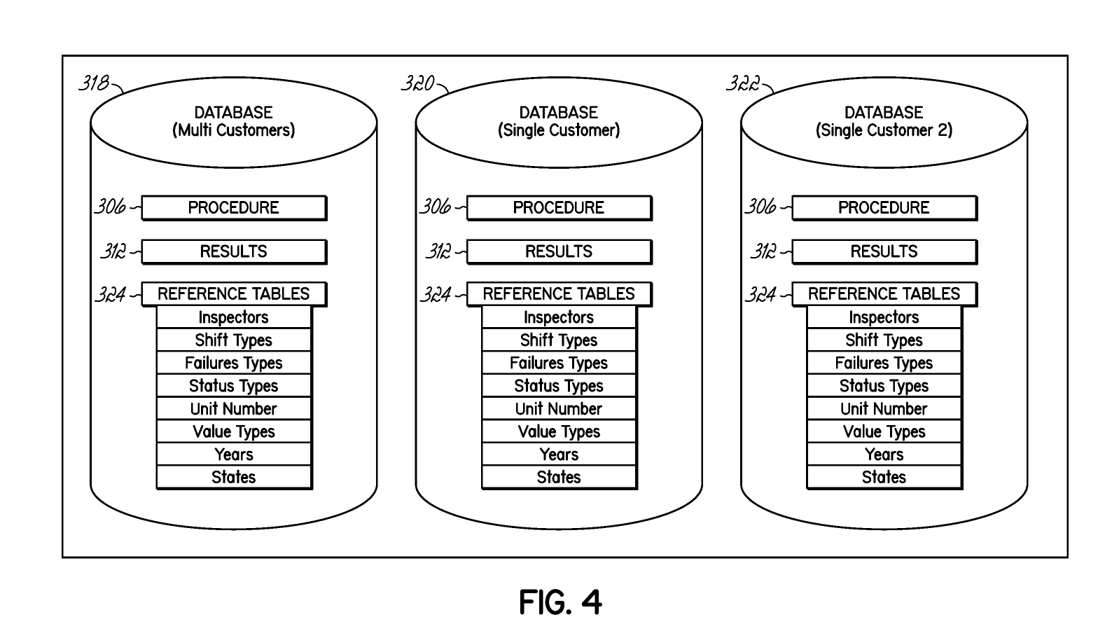

Although databases 304 and 310 are illustrated as separate databases in FIG. 3, they may just be portions of a larger single database hosted on a database server 108. For example, FIG. 4 illustrates embodiments whereby procedures 306 and results 312 are part of single large databases. Database 318 depicts an embodiment where the procedures 306 and results 312 for multiple customers or administrators are stored in a single database. In an alternative embodiment, each customer/administrator may have its own database of procedures 306 and results 312, as shown by databases 320 and 322. The databases described herein may also include reference tables 324, each which include data associated and/or used in conjunction with the procedures 306.

Although exemplary computer devices have been referred to for hosting the above described applications 132, it will be recognized by those skilled in the art that the described applications 132 may be hosted, either alone or in combination, on any device or devices similar to computer system 20 and/or is capable of executing the applications 132. For example, in some embodiments, the communication application 316 may be hosted on the same computer device or devices as the evaluation application 308. In other exemplary embodiments, the administrative application 302 and the evaluation application 308 may be hosted on the same computer device or devices. Given the typically endless number of manners in which applications 132 may be organized on computer devices, it should be appreciated that the invention is not limited to any specific organization and allocation of program functionality described herein.

In general, embodiments of the present invention may be considered in one or more separate parts, including the creation of various checkoff procedures 306 and the analysis of an object in accordance with a downloaded checkoff procedure 306. Each of these parts is described in greater detail below.

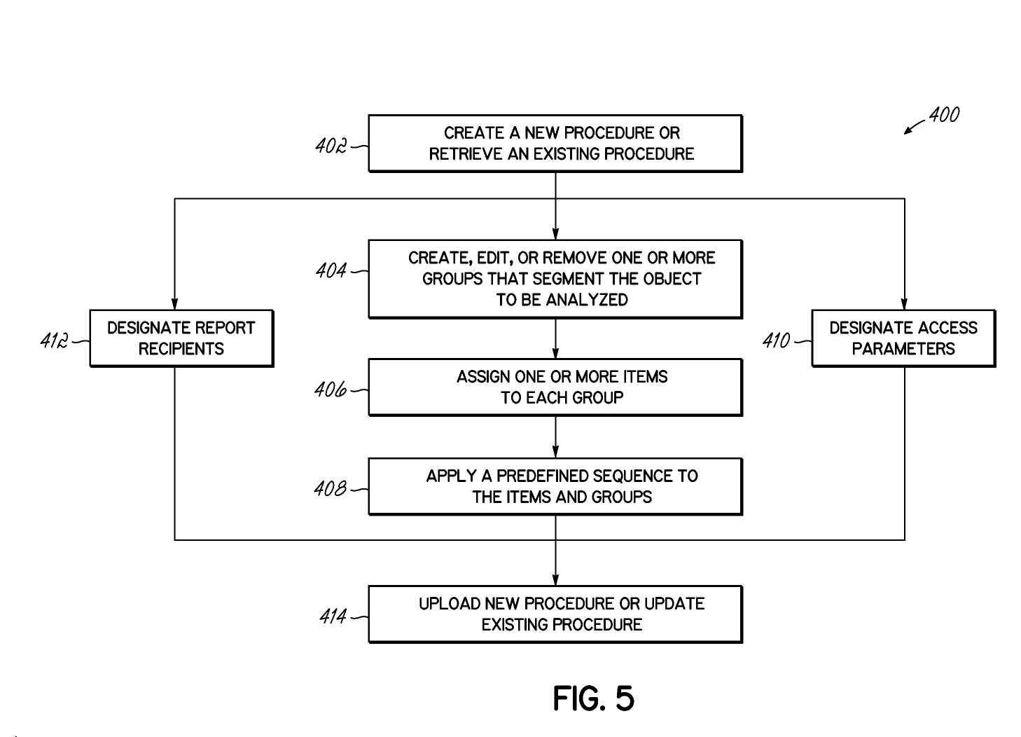

FIG. 5 provides a flowchart 400 that illustrates an exemplary sequence of operations for creating or updating a checkoff procedure 306 that may be used and performed by the administrative application 302.

To begin, the administrative application 302 may be configured to create a new procedure 306 and/or retrieve an existing procedure 306 from the procedure database 304 (block 402). Once a new procedure 306 has been created or an existing procedure 306 has been retrieved, the administrative application 302 is configured to create, edit, and/or remove one or more groups of the procedure 306 (block 404), and assign or populate the groups with certain items (block 406).

Typically, each group may be configured so as to segment the object to be analyzed into different aspects, locations, or areas of the object. For example, if the object being analyzed is an ambulance, then the groups may include, without limitation, locations such as an external compartment, an internal cabinet, a peds bag, and/or like aspects/locations of the ambulance. In accordance with one feature of the invention, during analysis of an object according to a procedure 306, a user is guided to evaluate only the items within one group at a time. By segmenting an object to be analyzed into multiple distinct groups, a user performing the analysis is encouraged to focus on one specific area or aspect of the object at a time, thereby reducing error caused by switching back and forth between different aspects, locations, or sections of the object. Moreover, the focus created by the groups helps to reduce imprecision and to increase uniformity by encouraging that objects of the same type or kind are analyzed in the same general order.

Once one or more groups have been created, the administrative application 302 may be configured to assign one or more items to each group, with each item including one or more attributes that are to be evaluated in relation to the item (block 406). In general, the recognized or assigned items may represent the “contents” of the object being analyzed and are what a user essentially evaluates or checks off while analyzing the object. For example, if the object being analyzed is an ambulance, then the items for the object will be typical items found or needed in an ambulance and may include, without limitation, sterile water, tape, life lines, sheets, and/or like items that would be associated with or found in an ambulance. The items preferably relate to one or more specific groups or locations in which each item is stored or contained.

The items for a particular object may be created on a procedure-by-procedure basis, meaning that new items must be created for every new procedure 306. Alternatively, the same items may be generally available for assignment into groups across multiple procedures 306. In certain embodiments, the administrative application 302 is configured to assign items directly to a group. Alternatively, the administrative application 302 may be configured such that each item is first assigned to a category before being assigned to one or more specific groups. The multi-label or hierarchal system of the invention offers a valuable organizational tool to a user that eases the process of configuring a procedure 306, especially in an embodiment where items are generally available for assignment into various groups across multiple procedures 306.

For example, some items may be assigned to a category labeled “ambulance” as they are created. Thereafter, when creating a new procedure 306 involving an ambulance as the object, a user may choose to display and select only those items that are assigned to the category “ambulance.” By displaying items by category, the complexity of creating a checkoff procedure and assigning each of the items to a specific group is greatly reduced because a user can display only relevant items for the category or object, as opposed to having to traverse through a list of both relevant and irrelevant items together. In some non-limiting examples, each item may be categorized by various factors, such as the object being reviewed, or by type, location, and/or other properties of the item, and displayed by category before being assigned to a group of the created checkoff procedure 306.

In accordance with another aspect of the invention, each item to be selected for a group may have one or more attributes associated therewith. The attributes of an item represent one or more aspects of that item that are to also be evaluated as part of the overall evaluation of the item itself and the object. Therefore, each attribute assigned to an item represents an aspect of the item that a user will evaluate when performing the analysis. To this end, administrative application 302 may be configured to assign attributes to one or more of the items that are to be evaluated so that the attributes are used as part of the analysis of the object. This adds a level of granularity other than just a list of items.

In some embodiments, an attribute may include, without limitation, the status of the evaluation for the particular item. In some embodiments, the administrative master 302 is configured to allow an administrator to predefine a list of possible statuses for an item that can be indicated by the evaluator. In other embodiments, the status attribute could allow the evaluator to input custom statuses. Exemplary statuses include whether the item itself has been evaluated, has yet to be evaluated, and/or if evaluation is currently pending. Moreover, the status attribute may also indicate whether the item has passed evaluation or failed the evaluation, and, if an item has failed the evaluation, the status attribute may be associated with a rationale for failing. To that end, the administrative application 302 may be configured to set a list of possible rationales for an item failing, which may be referred to as “exceptions.” Alternatively and/or in combination, an evaluator may be able to enter custom rationales for the failure of an item during an analysis.

For example, the rationale for a failed evaluation may include, without limitation, that the item is broken, is missing, and/or is leaking. As previously mentioned, in some embodiments, the administrative application 302 is configured to allow an administrator to pre-specify the possible selectable, fixed rationales, such that the user performing the analysis of the item will only be able to pick from the rationales specified in the administrative application 302. Alternatively, the administrative application 302 may be configured so as to allow a user/evaluator performing the analysis to input a custom rationale as to why evaluation of an item has been checked off as having failed.

In some embodiments, the status attribute may be a default attribute that is present whenever a given item is activated for evaluation (i.e., is turned on for a given procedure). In general, if an item is activated by the administrative application 302 for a given procedure 306, then the item will be displayed for a user when a user is analyzing the object corresponding to the procedure 306.

In some embodiments, an attribute may also include a value type that is associated with the item. Possible exemplary value types for an item may include quantity, size, quality, and/or any other like value types. If a value type attribute is associated with an item, then a user will be prompted to check that value type (e.g., the quantity of item) during evaluation of the item. In some embodiments, the variety of available value types is based on a predetermined set. In alternative embodiments, the administrative application 302 may be configured to allow users/administrators to create custom value types in addition to or instead of the predetermined set for a particular item when a procedure is created.

In some embodiments, the resulting evaluation of a value type is configured to be input into a logic test as part of the procedure. The logic test or portion of the procedure may then return a result based on the outcome. For example, if a quantity value type attribute is configured for an item, the attribute may also be configured such that, if the quantity is below a certain level or threshold, the status attribute for the item may automatically be marked at “FAILED” and/or a notification of low quantity will be generated in a resulting report. In some embodiments, the item is configured such that a particular rational/exception for the failure of the item is automatically selected based on the entered value type and the logic test (e.g., “short”).

In some embodiments, an attribute includes an expiration date test of an item. For example, evaluation of an expiration date test attribute may comprise a user/evaluator entering an observed date of expiration of an item during the analysis. If the expiration date input by the user/evaluator is prior to the date on which the object is being analyzed, the status attribute for the item may be configured to be automatically marked as “FAILED” and/or a notification may be generated in a resulting report indicating that the item is expired and must be replaced. In some embodiments, the item is configured such that a rational/exception indicating that the item is expired is automatically selected based on being past the entered expiration date (e.g., “expired”).

In other embodiments, an attribute includes a request for a user performing an analysis to enter additional information, typically in the form of text. For example, upon evaluation of the item, a text field may be generated, based on user input, for the user to provide any additional observations about the item and/or attributes associated therewith.

With respect to the attributes, the administrative application 302 may also be configured to designate how a user may record evaluations of the various item attributes while performing an analysis on an object. For example, the administrative application 302 is configured to set the type of input that may be made for each attribute, such as designating that the input must be a number, within a range of numbers, text, in a particular format, and the like, thereby enhancing data entry. Furthermore, the administrative application 302 may be configured to customize and/or abbreviate (typically for the case of smaller screens such as touch screens on mobile devices) the names of the items and/or attributes presented to the user performing the analysis. The administrative application 302 may also be configured to provide further information to help guide the user during the analysis. For example, when a quantity value type attribute is presented to the user for evaluation, the field for entering the corresponding quantity can be configured to have a prefix reciting “Number of items:” Alternatively, for example, the additional guidance is in the form of providing information as to how to evaluate a certain attribute. For example, the additional guidance might explain to a user where the expiration date of an item is located.

Once one or more items having attributes associated therewith have been assigned to the groups, the administrative application 302 is configured to allow a predefined evaluation sequence to be applied to the items and groups (block 408). In general, the predefined procedure sets forth the order in which the groups and items are to be evaluated as part of the overall process of analyzing or reviewing an object. Accordingly, the predefined evaluation sequence defines the order in which the groups and items are presented to a user/evaluator in a user interface for evaluation.

In addition to managing the groups and items of each created checkoff procedure 306, the administrative application 302 may also be configured to designate devices (via the client passcodes, for example) and/or users that may access the new procedure or retrieved procedure 306 (block 410). For example, the administrative application 302 may be configured to designate user names that must be entered by the user/evaluator performing the analysis before access is granted to the procedure 306. Moreover, the administrative application 302 may be configured to require two user names that must be entered, as well as designate which username may be entered as a first user and which username may be entered as a second user, and which usernames may be entered in both. In addition, the administrative application 302 may be configured to designate units and/or shift numbers that must be entered before a procedure 306 is made available. In addition to facilitating access control, the aforementioned information may be used to organize the results 312 of results database 310, thereby allowing recall of the results 312 by a computer device based on some or all of the above information being entered and/or transmitted to the results database 310.

In some embodiments, the administrative application 302 is configured to create and designate particular client passcodes, administrative passcodes, customer numbers, and/or other identifiers that must be used to access the checkoff procedure 306. As previously mentioned, client passcodes are generated by and internally stored on each of the administrative clients 106 and/or mobile devices 104 (FIG. 1). The administrative master 102 and/or administrative clients 106 may be aware of such client passcodes and the device each is associated with. For example, the administrative master 102 may be aware of the client passcode for each administrative client 106 and mobile device 104 associated with the administrative master 102, and each administrative client 106 may be aware of the client passcode for each mobile device 104 associated with that administrative client 106. Further, each of the administrative master 102, the administrative clients 106, and the mobile devices 104 may internally store the customer number and the administrative passcode associated therewith. Thus, whenever an administrative client 106 or a mobile device 104 tries to access the procedure database 304, the customer number, administrative passcode, and/or client passcode stored thereon may be automatically transmitted to the procedure database 304, thereby granting that device access if appropriate. In addition to facilitating access control, the customer number, administrative passcode, and/or client passcode may be used to organize the results 312 of the results database 310, thereby allowing recall of the results 312 by a computer device based, at least in part, on the customer number, administrative passcode, and/or client passcode.

Administrative application 302 is also configured to designate recipients that may receive a report based on the results 312 of an analysis conducted pursuant to the procedure 306 (block 412). For example, administrative application 302 may be configured to specify a name, cell-phone number, service provider, and/or E-mail address for any recipient that should receive a report based on the results 312 of the analysis. Consequently, the report, which may be compiled and sent by the communication application 316, may be transmitted by E-mail, text message, and/or any other suitable communication protocol to one or more recipients.

Administrative application 302 may include additional tools to help streamline the procedure creation process. In one embodiment, administrative application is configured to create new procedures 306 by copying an existing procedure 306, including the groups, items, attributes, and all the configuration data of the existing procedure 306. Thereafter, the administrative master 302 may allow a user/administrator to make changes to the new procedure. Alternatively and/or in combination, each procedure 306 may be associated with an object type, such as a certain model of ambulance for example. The object types stores a template of groups that segment that object. Hence, whenever a new procedure 306 is created for a given object, the new procedure 306 can be associated with the corresponding object type to pre-populate the groups of that new procedure 306 based on the template. In that way, the creation of new procedures is more efficient, as a user/administrator does not have go through the object and split it into various groups manually.

Thus, the object types enable an administrator to quickly create two procedures for two identical or substantially identical objects such that each procedure has the same groups. Furthermore, the object types facilitate the efficient creation of two different procedures for the same object. For example, an administrator may wish to create a weekly procedure and a monthly procedure for the same object, where each procedure includes the same groups, but different items within each group. The object types facilitate the creation of such procedures. In addition, the object types encourage the creation of complete and consistent procedures by assuring that at least the most relevant groups that segment the object associated with the procedure will be analyzed.

Once a particular checkoff procedure 306 is finished being configured, created, or revised, administrative application 302 may be configured to upload the data relating to the new or updated/revised procedure 306 to procedure database 304 to be stored therein (block 414). In some embodiments, if an existing procedure 306 has been updated, the administrative application 302 may be configured to upload only data representing the changes made to procedure 306, rather than the entire procedure 306, thereby saving the amount of data that must be communicated between administrative application 302 and the procedure database 304. For example, if a change or revision has been made to a portion of the procedure 306 or data associated therewith, such as changing an attribute of an item, the administrative application 302 may be configured to automatically mark the data corresponding to any change or revision. Thereafter, once the procedure 306 is ready to be saved or otherwise uploaded to the procedure database 304, the administrative application 302 may be configured to upload only that data which is marked as revised/changed. In some embodiments, the administrative application 302 may be configured to create a secure shell (“SSH”) connection with the computer device hosting the procedure database 304, such as the database server 108, to facilitate secure transmission of the procedure 306 to the database.

In general, the administrative application 302 is configured to perform the sequence of operations from flowchart 400 in response to an administrator or other user interacting with an appropriate administrator interface 303, thereby instructing the administrative application 302 to perform the operations, and create one or more procedures. In some embodiments, the administrative application 302 may be configured to automatically perform one or more of the operations of flowchart 400 without an explicit instruction by a user. For example, the administrative application 302 may be configured to automatically upload changes to a procedure 306 to the procedure database 304 without a user explicitly instructing the administrative application 302 to do so. In other embodiments, however, the user must explicitly direct that the changes are to be uploaded.

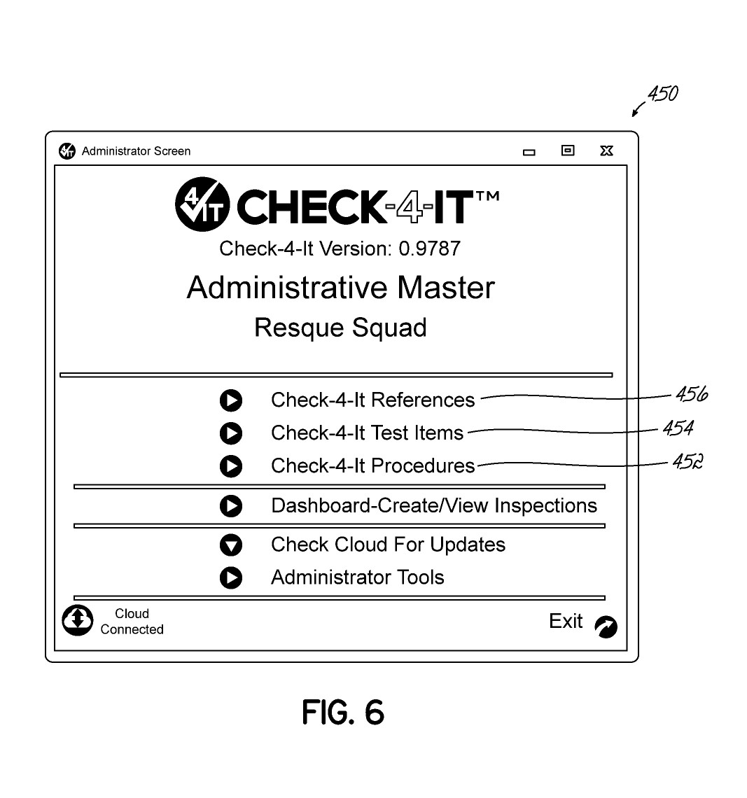

As described above, the administrative application 302 is configured to generate an administrator interface 303 or user interface by which a user can input information or enter data into the administrative application 302, thereby controlling the functionality of the administrative application 302 and creation of the various checkoff procedures. FIGS. 6-13 illustrate exemplary graphical user interfaces that may be generated by the administrative application 302 and/or may be included in the administrator interface 303 for such a purpose.

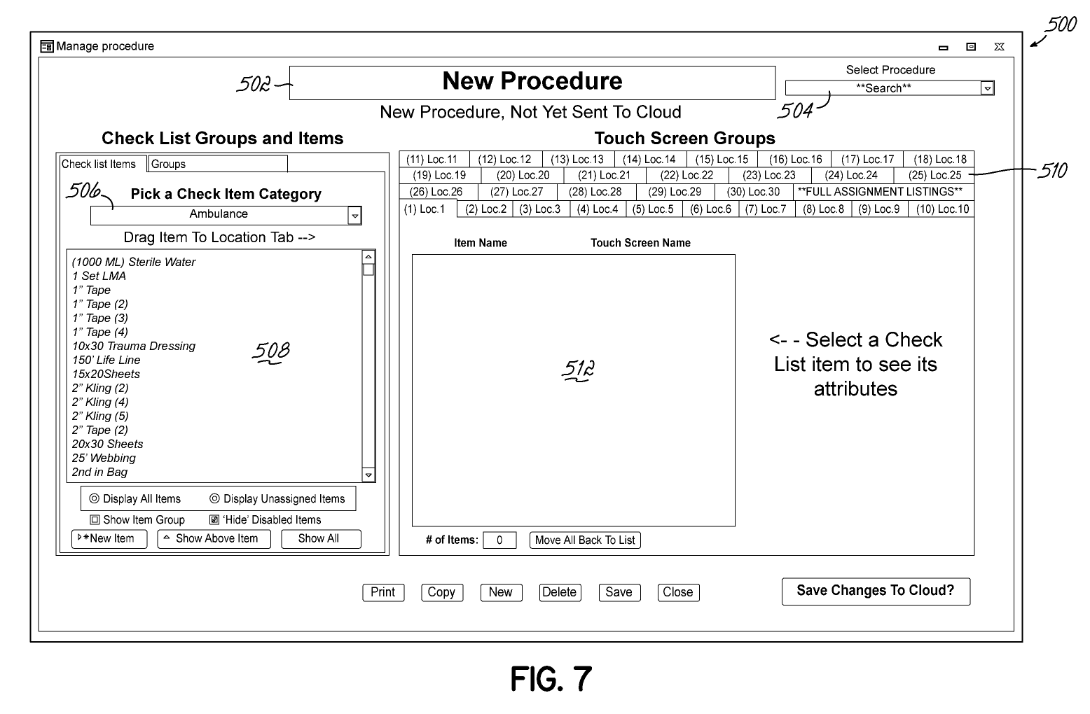

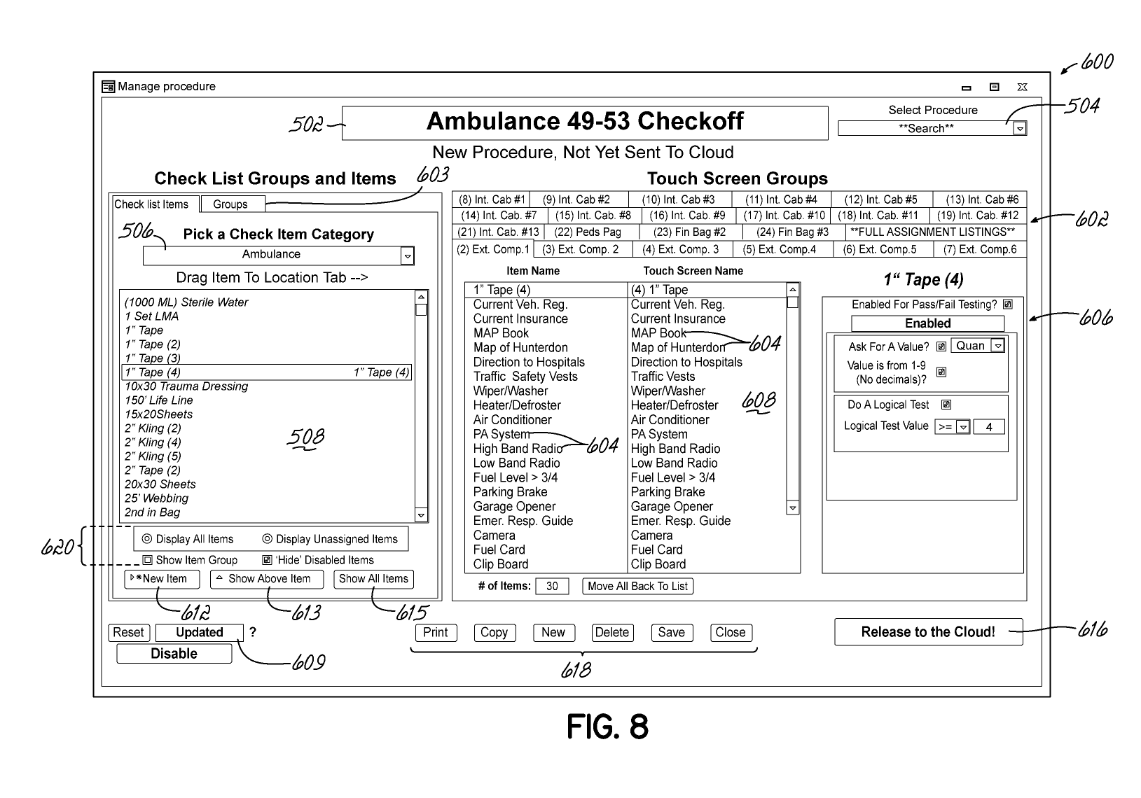

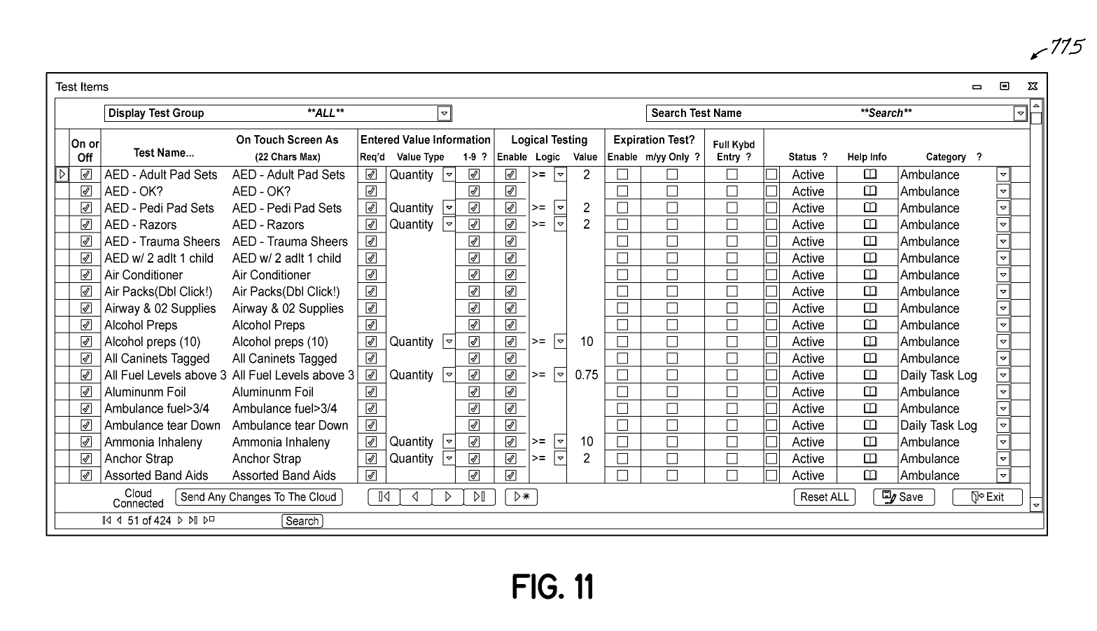

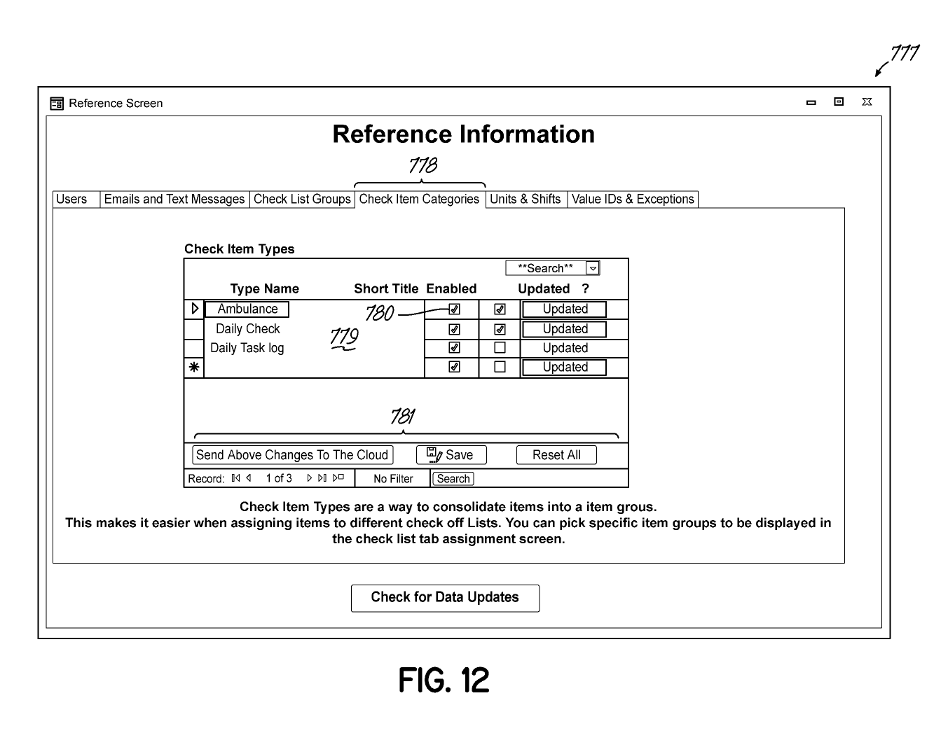

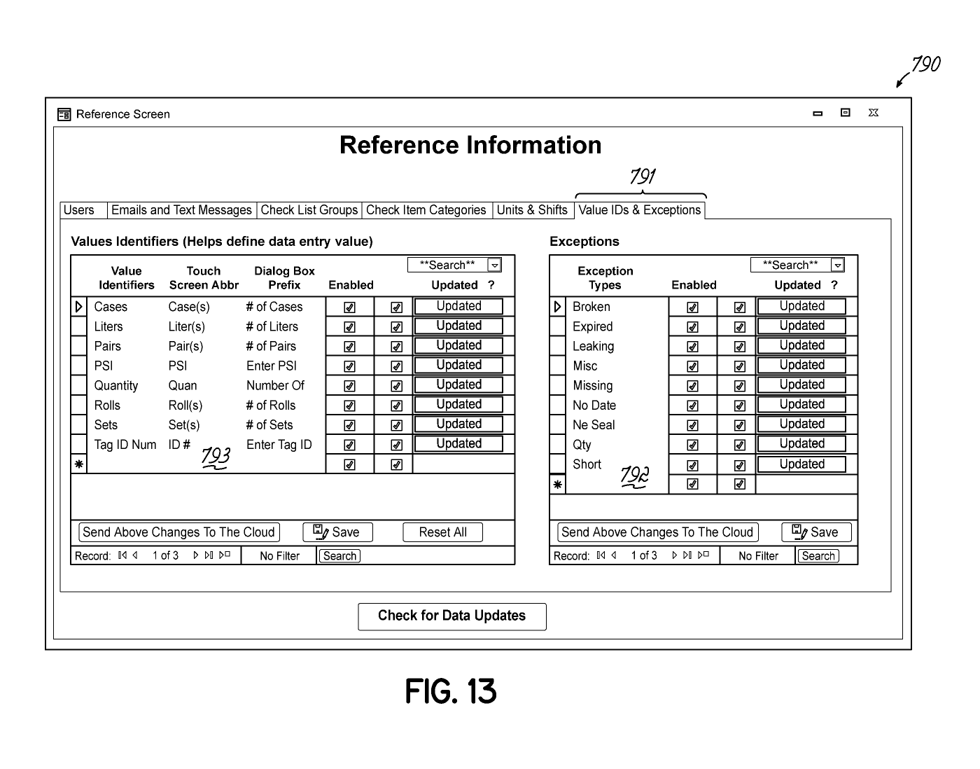

FIG. 6 provides an example illustration of a graphical user interface (“GUI”) 450 that may be generated by the administrative application 302 when first accessed. GUI 450 illustrates several interactive elements that a user may select to create new procedures, edit existing procedures, and edit items available to procedures, edit reference information for procedures, and the like. For example, GUI 450 illustrates procedure element 452 that may be interacted with to display an interface for creating a new procedure or updating an existing procedure (e.g., FIGS. 7 and 8). GUI also shows test item element 454 that may be interacted with to display an interface for viewing or editing all items and their attributes that have been previously created for the various procedures, as well as create new items (e.g., FIG. 11). In addition, GUI 450 shows reference element 456 that may likewise be interacted with to display an interface for setting reference information relating to one or more of the procedures, including the check item categories, those who will receive reports based of an analysis conducted according to the procedures, set the rationales or exceptions as to why an evaluation of an item has failed, and the like (e.g., FIGS. 12 and 13).

FIG. 7 provides an example illustration of a GUI 500 that may be generated when a new procedure 306 is created, such as by selecting procedure element 452 from GUI 450 (FIG. 6). GUI 500 illustrates a name field 502, with which a user may interact to name or to change the name of the new procedure 306. GUI 500 also illustrates a list of available items that have been categorized and arranged to be selected for a specific group. The items are arranged per category to be assigned to one or more groups of the new procedure 306. For example, in FIG. 7, items have been assigned to a category entitled “Ambulance” listed in a category field 506. As described above, these categorized items may have been created at some earlier stage in the past, either for another procedure 306 or for the currently loaded procedure 306. In some embodiments, as illustrated in GUI 500, category field 506 may include a category drop down list. If the category drop down list is selected by a user, a list of various selectable categories is displayed, and a category may be appropriately selected. As shown in GUI 500, once any of the categories is selected, the corresponding items that are assigned to that category are presented in the category display 508 as shown for use in the checkoff procedure.

FIG. 7 also illustrates the various groups 510 of items for the procedure. The items may be selected, as discussed herein, and assigned to a particular group for the procedure for the purposes of future analysis of an object in accordance with the principles of the invention. As discussed below, various items are selected from a particular category field 508, and placed in a group field 512. The groups may be named accordingly for a procedure to reflect what section, portion, or aspect of an object the group represents. Initially, the groups 510 are listed as various locations (e.g. Loc. 1, Loc. 2, etc.). Once the procedure is stored, the various selected items and groups will be stored as well for that noted procedure, as discussed with respect to FIG. 8.

In addition and/or alternatively, GUI 500 may be generated for searching and/or retrieving an existing procedure 306 from the procedure database 304. That is, a previously-created and stored procedure might be selected for use or revision. To this end, GUI 500 illustrates a search or retrieval field 504 for a user to browse and/or retrieve an existing procedure 306. In some embodiments, as illustrated in GUI 500, the retrieval field 504 may be a retrieval drop down list, which displays all existing created procedures 306 available for access by the administrative application 302. The list of available procedures 306 may be based on the current user and/or current computer device (having stored thereon a customer number, unique administration passcode, and/or client passcode) that is hosting the administrative application 302. By selecting a procedure 306 from the retrieval dropdown list, the procedure 306 is downloaded to the administrative application 302, thereby causing GUI 500 to populate the various group fields with the items and configuration of the downloaded existing procedure 306.

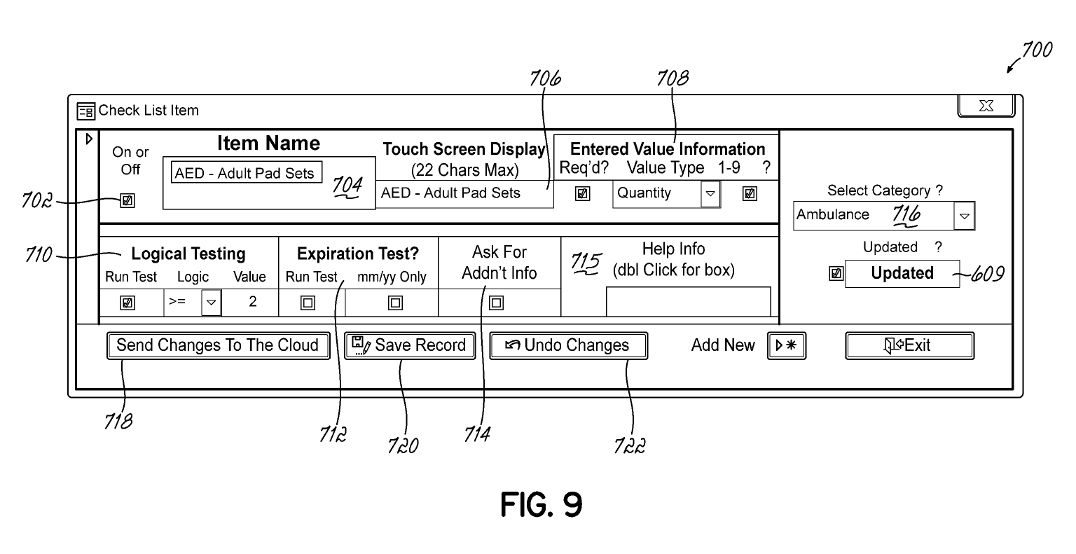

FIG. 8 provides an example illustration of a GUI 600, where an existing procedure 306 entitled “Ambulance 49-53 Checkoff” has been selected using the retrieval field 504. As illustrated in FIG. 8, once an existing procedure 306 is selected, the configuration of the selected procedure 306 is displayed in the administrator interface 303. Also, the items and groups associated with the procedure are retrieved and displayed. For example, GUI 600 includes the name of the selected procedure 306 displayed in name field 502, as well as the associated groups 602, items 604, and a selected item's (e.g., 1′ Tape(4)) corresponding attributes 606. The displayed attributes 606 of a selected item 604 may be edited via GUI 600. Additionally or alternatively, selection, such as by double clicking with a mouse, of an item 604 may bring up a new window for editing the attributes 606 of the item 604 (e.g., GUI 700 of FIG. 9).

GUI 600 also illustrates that the procedure 306 entitled “Ambulance 49-53 Checkoff” has been segmented into a specific plurality of groups shown in group field 602. The groups comprise or are associated with various aspects of the object to be analyzed or assessed. For example, with the ambulance procedure of FIG. 8, various locations or areas of Ambulance 49-53, such as “int. cab. #1,” “int. cab. #2,” “Fin Bag #2,” and “Ext. Comp. 1,” “Ext. Comp. 2,” and so on is illustrated by interface 600. The plurality of groups in group field 602 for a specific procedure are arranged in a numerical order, as illustrated in GUI 600 shown in FIG. 8. The order illustrated within the group field 602 provides an indication of the order in which the groups, and consequently the items of each group, will be presented to a user on a device, such as a mobile device including a touch screen interface, during an analysis according to the procedure 306. That is, a user conducting an analysis according to the procedure will be presented with the items of the first group indicated for location 1 until each item is checked off, and then will be presented with the items from group 2, and then group 3, and so on and so forth, as discussed further hereinbelow.

Accordingly, referring to FIG. 8, a user analyzing an object according to the procedure 306 entitled “Ambulance 49-53 Checkoff” will be guided, for example, to evaluate or check off all items of “Ext. Comp. 1”, which is in group (2) of field 602, before proceeding to “Ext. Comp. 2”, which is in group (3) of field 602″, and so forth. In some embodiments, a group or location can be hidden for a given procedure such that it will not be shown to the user conducting the analysis, which is illustrated in GUI 600 by way of the absence of group (1). The hiding of a group 602 for a given procedure 302 can be especially beneficially when the procedure 302 has been copied from another procedure 302 or has been created from an object type template, described above.

An erroneous analysis is more likely to occur when an evaluator is switching back and forth between multiple sections or locations of the object being evaluated. Therefore, the invention provides a significant benefit by segmenting an object into groups or locations, such as those of GUI 600, and presenting the groups to a user, through an interface, in a logical, selected order. This encourages the user conducting the analysis to complete evaluating one area, location, or other aspect of the object before moving on to the next, so that no portions or sections of the object are missed.

Referring to FIG. 8, when creating groups, various items displayed in the category field 508 may be selected and moved to display field 608 for a particular group. Each item may be selected and moved by clicking on the item and dragging and dropping the item from field 508 to field 608. In that way, various items of the category may be selected for a particular group as items 604 of that group for the purpose of analysis. For example, as shown in GUI 600, an item 604 named “1” tape (4)” has been dragged from display field 508 to the group display field 608 of the currently selected group 602. As noted hereinbelow, those selected items will be displayed as part of the checkoff procedure.

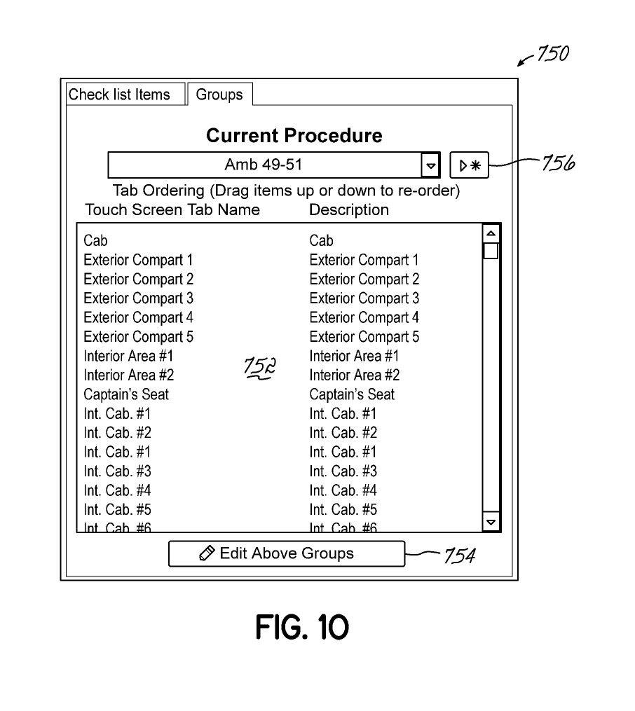

The selection of the item 604 and its placement in field 608 also will determine the order in which the item is displayed and processed for a particular group during analysis of the item. GUI 600 illustrates that a predefined sequence may be applied to the procedure 306 by dragging each item to a desired position within a group display 608. The items may be moved around, as appropriate with a cursor, for example, for the desired order. Similarly, in one embodiment, the predefined sequence may be further defined by dragging the groups into a desired order in field 602. For example, as shown in exemplary GUI 600, a predefined sequence has been assigned such that the items 604 assigned to the group of field 602 entitled “Ext. Comp. 1” will be displayed and processed before the items 604 assigned to the group of field 602 entitled “Ext. Comp. 2,” and so on. Within each group, the items 604 are also arranged such that, in the group presently displayed in the group display 608 of FIG. 8, the item entitled “1” tape (4)” will be presented for evaluation before “Current Veh. Reg. and so on. In alternative embodiments, the predefined sequence of groups is defined via a separate drag and drop interface (e.g., FIG. 10) generated by the administrative application 302 in response to selecting an option to edit the groups, such as tab 603 in GUI 600. The drag and drop interface, described hereinbelow, may also facilitate adding new groups or deleting existing groups from the procedure.

Group display 608, as illustrated in FIG. 8, also may provide a split display for indicating alternative names for a selected item. For example, the item that is selected for a particular group, as illustrated in FIGS. 7 and 8, may be given one particular name when created or categorized. Such a name is indicated on the left side of field 608, as illustrated in FIG. 8. However, when the item is later displayed for a user, such as on the touch screen of a mobile device, the item might be given an alternative name, as shown on the right side of field 608 in FIG. 8, for real estate considerations on the screen, as discussed below. Often, the different names are similar; however, there may be instances where they are different due to real estate issues. For example, for the item shown in field 608 of FIG. 8 indicated as “traffic safety vests,” the item is configured to be displayed as “traffic vests” when displayed on a touch screen device.

In addition, the administrator interface 303 may provide an indication of updated items, groups, or other portions of a procedure for a user to see. GUI 600 illustrates an update indicator 609, which may either display and/or otherwise change whenever a procedure 306 is changed. In some embodiments, the update indicator 609 may be an icon that appears, changes color, and/or changes appearance whenever an aspect of the procedure 306 is changed, as shown in GUI 600. Alternatively and/or in addition, the update indicator 609 may include a checkbox that is checked whenever a change is made to the procedure 306. The update indicator 609 may be included on any screen of the administrator interface 303 generated by the administrative application 302 where an aspect of the procedure 306 may be changed (e.g., FIG. 9). Further, one or more screens of the administrator interface 303 may include a plurality of update indicators 609, one for each aspect of the procedure 306 that is editable on a given screen. For example and without limitation, if a screen of the administrator interface 303 includes a list of user created value type attributes, as described above, and one of those value types is edited, then an update indicator 609 may appear, change color, be checked, and/or change appearance corresponding to the edited value type. In that way, an administrator or other user setting up a procedure will know what has been changed and when new data should be saved to the procedure database 304.

GUI 600 also illustrates a cloud element 616, which, when selected by a user, may send the new and/or updated procedure 306 to an appropriate procedure database 304, such as a cloud-based database. As shown in GUI 600, the cloud element 616 may be in the form of a selectable button.

The interface 600 illustrated in FIGS. 7 and 8 also may include additional selectable fields or control elements for processing a procedure. For example, selectable control fields 618 might be used for deleting, saving, or closing a procedure, as appropriate. Selectable control fields 620 might be used for affecting or arranging the look of display field 508, and presentation of the items listed therein. Accordingly, various different views of the display field 508 and the items therein might be presented to a user in accordance with their desires. This also provides a more streamlined selection and arrangement of items for the user's convenience.

In addition to the items displayed in field 508 for a particular category, new or additional items may also be created in the invention. That is, a user may create new items for one or more categories that may then be selected and arranged in an appropriate group, as discussed herein. Each item might be created and linked with appropriate attributes for the item, depending upon the item created. As noted above, each item may have one or more attributes associated therewith, which further direct or control the engagement of a user/evaluator with the item in a checkoff procedure for an object or some other analysis processed for an object. For example, certain attributes, such as status attributes, value attributes, expiration attributes, or logical testing attributes might be assigned to, or associated with, a created item. In accordance with one aspect of the invention, the user can control the attributes that are enabled or associated with a particular item.

Referring to FIG. 8, when a particular item is selected or highlighted in field 608, such as 1″ tape, the various attributes associated with that item are displayed, such as in field 606. In that way, a user who is creating or revising a procedure may see what particular attributes are associated with a selected item for the displayed group 602 and, in some embodiments, edit those attributes via field 606.

FIG. 9 provides an example illustration of a GUI 700 that is generated by the administrative application 302 in response to a user selecting to create a new item, such as by selecting new item button or field 612 (FIG. 8). GUI 700 may also be generated in response to a user selecting to edit an existing item, such as by double clicking the item in display field 508 or by selecting the item with a single click and choosing show item button or field 613 (FIG. 8).

GUI 700 illustrates an enable field 702, which might be selected (or deselected) for turning the item ON and OFF, which designates whether the item will be presented to a particular user conducting an analysis of an object corresponding to the procedure 306. Once an item is enabled or turned ON, various attributes might be selected or enabled to be associated with the item. As shown in GUI 700, the enable field 702 may be in the form of a checkbox to be checked or unchecked.

GUI 700 also provides options for naming an item, and illustrates a general name field 704 and touch screen name field 706, which may be interacted with to adjust the name of the item presented to a user while conducting an analysis. An alternative, shorter name is possible. The name recited in the touch screen name field 706 is displayed when a user is conducting the analysis on the smaller display, such as a mobile device touch screen.

In addition, GUI 700 illustrates a value type field 708 that might be enabled/checked for associating a value type attribute with the item. As illustrated, the value type field 708 may include a drop down list for selecting the particular value type and checkboxes for further customizing the attribute. For example, one checkbox may designate whether evaluation of the value attribute is required, and provide a selection of the type of value (e.g., “quantity”) from a drop down menu. That type of value must then be provided as an attribute for the item in the checkoff process. Another checkbox may designate whether the user performing the analysis can enter a number without also having to click an “Enter” button, thereby enhancing data entry (e.g., “1-9?”). More particularly, GUI 700 shows that “Adult Pad Sets” has been configured to include a required “quantity” value type attribute with enhanced data entry, which will indicate to a user to actually count the number Adult Pad Sets and enter that value as part of their evaluation or analysis. Moreover, the value type field 708 may include an option to create custom value types, as discussed above.

GUI 700 also illustrates a logic field 710 for having the value type attribute and the data that is entered by a user run through a selected logic test. As illustrated in GUI 700, logic field 710 may include a drop down list for selecting among a plurality of logic operations, a checkbox to enable the test, and a field for inputting a constant value or threshold value to be tested against. According to the logic test set up in GUI 700 in FIG. 9, for example, that data entered by a user for the number of Adult Pad Sets must be greater than or equal to 2, and if the number of Adult Pad Sets is less than 2, a notification may be generated in a resulting report that indicates additional Adult Pad Sets must be added for the object that is being analyzed, such as an ambulance or a supply or storage location for an ambulance. In some embodiments, failing the logic test will automatically designate the status of the item as “FAIL.”

The GUI 700 also illustrates an expiration field 712 for adding an expiration test attribute to the item. As illustrated in GUI 700, expiration field 712 may include a checkbox for enabling the attribute and a checkbox for enhancing data entry. For example, a date may be entered that will be checked against a current date. A checkbox might also be enabled to indicate to a user that they should only enter expiration month and year data. In some embodiments, if the current date is past the entered date during the analysis, the status of the item is automatically set to “FAIL.”

Furthermore, GUI 700 also illustrates an additional information field 714, which, when activated or checked, associates an attribute with an item that requests additional information for the item. Typically, the additional information requested comprises other observations and data about an item generated by a user during its evaluation. As shown in GUI 700, the additional information field may comprise a checkbox for enabling and disabling the attribute.

GUI 700 also illustrates a help information field 715, which may be interacted with to provide additional guidance to a user while evaluating the item. For example, if the expiration date of an item is required for the expiration text, and it is in an inconspicuous location, the help information field 715 may be used to provide information to a user/evaluator of the location of the expiration date of the item during the analysis.

GUI 700 also illustrates a category selection field 716 for assigning one or more categories for the item, as described above. As shown in GUI 700, category selection field 716 may be a drop down list, which, when selected, displays all available categories. As an example, GUI 700 shows that the item has been assigned to the category entitled “Ambulance.”

GUI 700 also illustrates a selectable “cloud” field 718, which, when selected by a user, may send the new and/or updated item to the procedure database 304. Alternatively, the item and its attributes may be saved locally (field 720), or various changes may be erased or undone (field 722). As shown in GUI 700, cloud field 718, save field 720, or undo field 722 may be in the form of a selectable button.

FIG. 10 provides an example illustration of a GUI 750 that is generated by the administrative application 302 in response to a user selecting to reorder the groups, such as by selecting groups tab 603 in GUI 600 (FIG. 8). For example, GUI 750 illustrates groups for a procedure entitled “Amb 49-51” and includes a group order display field 752. As is also illustrated in GUI 750, the group order display field 752 may be split into two sections, one which displays the group names as will be displayed on touch screen mobile devices, and one which displays a fuller description that may be displayed on larger computing devices. The names of the groups may be edited by selecting to edit a group, such as by selecting group edit button 754. New groups may also be added to the procedure, such as by selecting new group button 756. Similar to defining the predetermined order of the items within a group described above, GUI 750 illustrates an example embodiment whereby the predefined sequence of the groups may be defined by selecting and dragging each group relative to the others within the group order display field 752.

Additionally or alternatively, a substantially similar screen to GUI 750 may be generated when the object type templates described above are being used, and a user selects an option to edit the groups of an object type. For example, referring to FIG. 10, the title “Current Object” could be displayed in place of “Current Procedure,” button 756 could facilitate adding new objects, and field 752 could display the groups and order of groups for an object type selected in the drop-down menu. Furthermore, the order of the groups within the object type could be rearranged via dragging and dropping, and the groups themselves could be edited by selecting group edit button 754.

FIG. 11 illustrates a GUI 775 that may generated by the administrative application 302 in response to a user selecting to display all available items and their settings, such as by selecting show all items button 615 (FIG. 8) or test items element 454 (FIG. 6). As shown in FIG. 11, GUI 775 includes an expanded version of GUI 700 (FIG. 9) that displays all of the available items and their attribute settings.

FIGS. 12 and 13 illustrate exemplary reference screens that may be generated by the administrative application 302 in response to a user selecting to edit other aspects of the procedure, such as by interacting with reference element 456 of GUI 450 (FIG. 6). The various aspects that may edited include, without limitation, designating users, units, shifts, and report recipients associated with the procedure, creating or editing check item categories, designating a particular input type for an attribute of an item, and/or designating the potential rationales or “exceptions” that an evaluator may use to explain a failed status of an item.

For example, FIG. 12 illustrates an interface or GUI 777 that may be generated by the administrative application 302 upon a user selecting to edit the check item categories, such as by selecting check item tab 778. GUI 777 shows a category name display 779, which may be used to edit the names of the categories or create new categories. In some embodiments, the category name display 779 allows a user to set two names of a category, namely, a full or “type name” and a “short title,” which can be used for display on computing devices with smaller screens. GUI 777 also includes selectable elements, which may be in the form or checkboxes, for enabling each category such that it is shown when creating items (e.g., FIG. 9) and adding them to groups (e.g., FIG. 8). GUI 777 also illustrates other options 781 for sending changes to the categories to the cloud, saving the category changes locally, and resetting all changes.

FIG. 13 illustrates an interface or GUI 790 that may be generated by the administrative application 302 in response to a user selecting to designate the rationales or exceptions for a failed status of an item and/or designate specific input types for an attribute, namely the value type attribute discussed herein, such as by selecting tab 791. GUI 790 illustrates a value display 793, which a user may interact with to designate particular value types (e.g., cases, liters, pairs, etc.) The value display 793 may also include an option for a user to create an abbreviated name for touch screen devices and/or a dialog box prefix which will populate the attribute field in which an evaluator or user will input the value type during an analysis, thereby further guiding the evaluator or user as the proper input type for that value type. GUI 790 also illustrates exception display 792, which a user may interact with to designate a list of potential exceptions or rationales as to why an item has failed evaluation. Thus, upon marking an item as failing, the evaluator or user performing the analysis can choose one of these exceptions or rationales for the failure, which will be included in the report. In some embodiments, the evaluator or user may create their own customer rationales or exceptions during the analysis.

As noted, after the various items are created, categorized into a category, associated with attributes, and selected by an administrator or other user to create a procedure 306 for analysis of an object, the checkoff procedure 306 is run by a user and the various groups, items, and attributes of the procedure 306 are displayed for being checked. Thus, after one or more procedures 306 have been created and uploaded to the procedure database 304, the procedures 306 may be downloaded to the evaluation application 308, which may be configured to generate an evaluator interface 314 (FIG. 3) or other graphical user interface and thereby guide an evaluator or other user in conducting an analysis of the corresponding object. To that end, the evaluation application facilitates a user navigating through a checklist associated with the downloaded procedure 306.

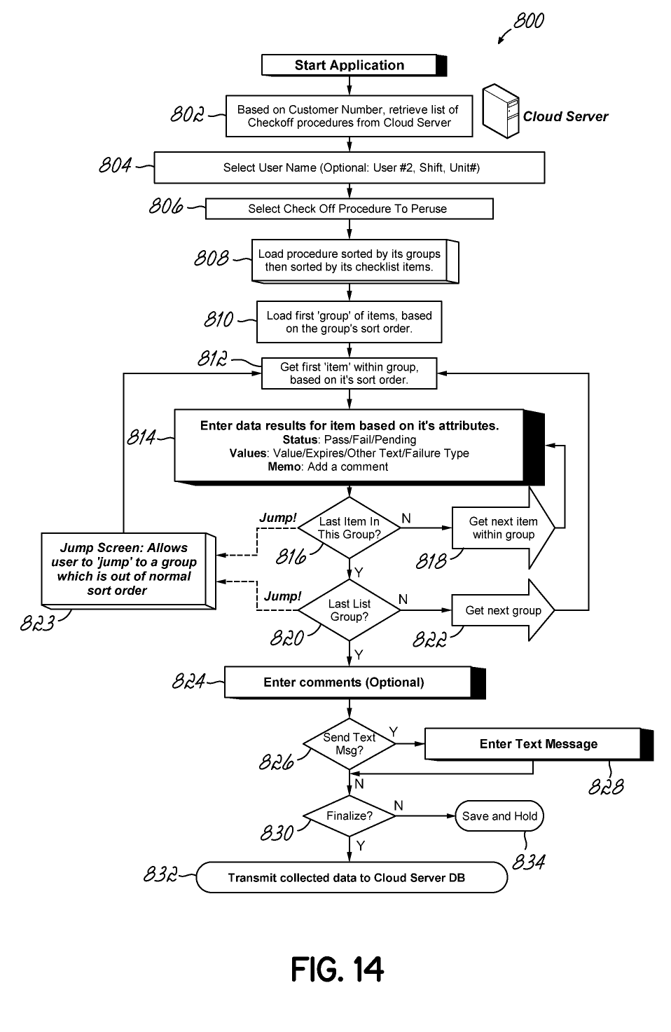

FIG. 14 is a flowchart 800 illustrating a sequence of operations for analyzing an object in accordance with a downloaded procedure 306, which may be performed by the evaluation application 308 in response to appropriate user input. In particular, based on a customer number, administrative passcode, and/or device passcode stored internally on the accessing device, as well as, in some embodiments, an entered username, unit, and/or shift, the evaluation application 308 retrieves a list of procedures 306 from the procedure database 304 (block 802). In the disclosed embodiment, the procedure is directed to an analysis that involves one or more checkoff lists or checklists, and so herein, the procedure is referred to as a checkoff procedure, as noted in block 802. In some embodiments, the list may include only those procedures 306 that are associated with the specified customer number, unique administrative passcode, and/or client passcode associated with the device attempting to download the procedure 306 for use in application 308. In some embodiments, the list of available procedures 306 may be based on an entered username, a second username, shift, and/or unit (block 804). Thereafter, in response to the user selecting a procedure 306 from the list (block 806), the evaluation application 308 may download and load the selected procedure 306 from the procedure database 304 (block 808).

The loaded procedure will have a hierarchy or predefined sequence associated with the various groups, items, and attributes created by an administrator or other user when creating the procedure, as discussed herein. Once the downloaded procedure 306 is loaded, the evaluation application may load the first group thereof (block 810). As discussed above, each group may be defined so as to segment the object being analyzed into various locations, aspects, parts, or portions. Thereafter, the evaluation application 308 may retrieve the first item of the first loaded group (block 812). As discussed above, each item may represent the contents of the object being analyzed and may be “checked off,” or otherwise evaluated by a user according to one or more attributes associated with the item.

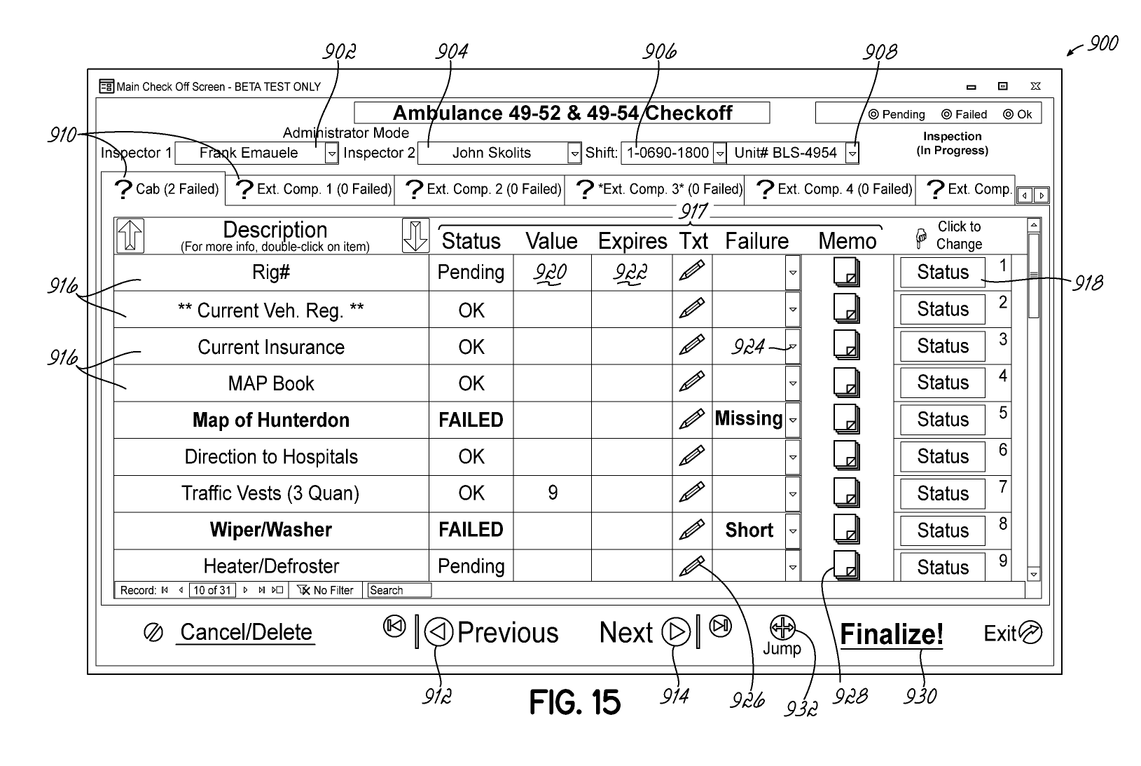

After the first item is retrieved, the evaluation application 308 is configured to generate an evaluator interface 314 comprising the item and its attributes, and a user interacts with the evaluator interface 314 based on an evaluation of each attribute (block 814). An exemplary evaluator interface, such as for use on a mobile device 104 (FIG. 1), is illustrated in FIG. 15. For example, if an item includes a status attribute as discussed above, then once evaluation of an item has begun, the user may mark the item's status as “Pending” or “Pass” or “Fail.” In addition, the user may enter a value type, replenishment amount, expiration date, additional text and/or failure type, or any other attribute data or information, depending upon if such attributes have activated/selected and thereby associated with the item being evaluated. The items listed for the user are checked off based on the user's observations of those items. Also, additional comments associated with an item may be entered.

The evaluation and progress through the checkoff procedure progresses item by item for each group, and then group by group, until the checkoff procedure is complete. After the user has finished evaluating the item and attributes of the present item, the evaluation application 308 may be configured to determine whether the most recently evaluated item is the last item of the currently loaded group (block 816). If there are additional items left in the presently loaded group (“No” branch of decision block 816), then the evaluation application 308 may be configured to retrieve the next item in the group and generate a new evaluator interface 314 based on the next item, with which the user may again interact with (block 818).

Conversely, if there are not any additional items left in the presently loaded group (“yes” branch of decision block 816) and the group checkoff procedure list is complete, then the evaluation application 308 may be configured to determine if the presently loaded group is the last group of the downloaded procedure 306 (block 820). If there are more groups within the procedure 306 that have yet be to be analyzed (“No” branch of decision block 820), then the evaluation application 308 may be configured to retrieve the next group and proceed to load the items of that group for evaluation (block 822). By contrast, if the presently loaded group is the last group of the procedure 306 (“yes” branch of block 820), then evaluation application 308 may be configured to generate an evaluation user interface 309 for finalizing the analysis of the object. By retrieving groups and their items in the above described way, the groups and items of each group are presented for evaluation according to the applied predetermined sequence determined by an administrator/user. In that way, a user progresses through the checkoff procedure in a logical or pre-determined fashion that will provide greater consistence and efficiency in the analysis of the object. That is, the user methodically is directed through each item and each group, and is presented with the various enabled attributes for the item to speed the checkoff process and collect all the information associated with an item.

If the user chooses, the evaluation application 308 may be configured so as to allow a user to jump to a specific group and/or specific item that is out of normal sort order (i.e., out of the predetermined sequence) (block 823). By including such an option, the evaluation application 308 provides flexibility for the checkoff procedure to allow a user to address one or more items out of a particular order. This allows flexibility for the circumstances in which a user, during an analysis, must handle or evaluate one or more items out of the normal order.

Before finalizing the analysis, the evaluation application 308 is configured to provide the user a field to enter additional comments pertaining to the analysis (block 824). In some embodiments, the evaluation application 308 is also configured, based on user input, whether to display to the evaluator and/or include in a report the information about items replenished during the analysis. For example, during an evaluation of an item, if the evaluator determines that an item is deficient, the evaluator may go to a backup supply and replenish the item. The evaluation application 308 may be configured to keep track of the amount of the items replenished and/or the inventory of the backup supply. Once the analysis is being finalized, if a user selects to include information relating to the items replenished, then the resulting report may include the number of each item that was replenished and/or the remaining inventory of the item in the backup supply.

Moreover, the evaluation application 308 is configured determine, based on user input, whether the user wishes to send out a message via text to one of the recipients designated by the administrative application 302 (block 826). If so (“yes” branch of block 826), the evaluation application 308 may be configured to provide a field for entering the message to be sent (block 828). If not (“no” branch of block 828), or after the user has specified the text message to be sent, the evaluation application 308 is configured to determine whether to finalize the analysis (block 830). If, based on user input, the evaluation application 308 determines that the analysis should be finalized (“yes” branch of block 830), then the evaluation application 308 is configured to upload the results 312 of the analysis to the results database 310 (block 832). Conversely, if, based on user input, the evaluation application 308 determines that the analysis should not yet be finalized (“no” branch of block 830), the evaluation application 308 is configured to save and hold the results of the analysis to be further edited and/or to be transmitted at a later time (block 834).

In general, the evaluation application 308 is configured to perform the sequence of operations from flowchart 800 for a certain checkoff procedure in response to a user interacting with the evaluator interface 314, thereby instructing the evaluation application 308 to perform the operations using a retrieved procedure. In some embodiments, the evaluation application 308 is configured to automatically perform one or more of the operations of flowchart 800 without an explicit instruction by a user. For example, the administrative application 302 may be configured to automatically retrieve the next items and/or group in response to the evaluation of an item being complete. In other embodiments, the user must explicitly direct that the next group and/or item be retrieved.

As described above, the evaluation application 308 is configured to generate an evaluator interface 314 by which a user can input information into the evaluation application 308 and progress through the checkoff procedure, thereby controlling its functionality. FIGS. 15-19 illustrate exemplary graphical user interfaces that may be generated by the evaluation application 308 and/or may be part of the evaluator interface 314.

FIG. 15 provides an example illustration of an evaluator or user interface or GUI 900 that may be generated by the evaluation application 308 in response to a user electing to analyze an object according to a checkoff procedure 306 entitled “Ambulance 49-52 and 49-54 checkoff.” GUI 900 illustrates several fields that may be configured for identifying a user. As illustrated in GUI 900, the fields may include a field for selecting a user name of the first inspector 902, a user name of the second inspector 904, a shift 906, and/or a unit number 908.

Further, GUI 900 illustrates various groups of a downloaded checkoff procedure 306 as tabs 910 ordered by the predetermined sequence that is part of the checkoff procedure 306. The order of the groups may be selected and arranged, as disclosed herein. Although a user may select the various tabs to skip between the groups, GUI 900 of the invention directs and encourages a user to evaluate the items according to the predetermined sequence of the groups and within a group. The user might also selectively go through the items and groups using button fields that provide a previous element 912 or a next element 914, which allows a user to advance selectively between the items and the various groups. Alternatively, the user might choose to jump between locations and items, such as by selecting jump element 932, described hereinbelow. GUI 900 also illustrates that within each selected group, the items 916 are listed in the order by which they should be evaluated in accordance with the predetermined sequence associated with the checkoff procedure 306. For example, as shown in GUI 900, the item 916 entitled “Rig #” should be evaluated before the item 916 entitled “**Current Veh. Reg.**”, and so on.

GUI 900 also illustrates various items 916 that include interactive elements for analyzing the attributes 917 associated with the particular item 916. For example, a user may select button 918 to change the status of the item 916 entitled “Rig #” between “Pending,” “OK”, and/or “FAILED.” Alternatively and/or in combination, the evaluator may input customized statuses. Depending on the item's current status, the background color of item 916 may change. In addition, a user may interact with fields 920 and/or 922 to input information relating to a value type attribute and expiration date attribute of each item 916, respectively. In preferred embodiments, only characters and/or numerals consistent with the attribute being evaluated may be entered within fields 920 and 922. For example, field 920, which relates to the value type attribute, may only contain a number. Similarly, field 922, which relates to the expiration date attribute, may only contain a date. Such requirements for the fields for each attribute may be designated through the administrator interface 303 and the administrative application 302. In some embodiments, any logic test performed on the entered value attribute, as described in reference to the application master 302, and/or entry of a value of the expiration field may automatically cause the status of the item to change to “PASS” or “FAILED.” For example, if the current date is past the input expiration date, the status may automatically change to “FAILED.” In some embodiments, the rational field 934 may also automatically state the reason (e.g., expired) in response to the value attribute or expiration entry causing the item to fail its analysis.

Thus, GUI 900 also illustrates a rationale field 924 that may allow a user to input an explanation as to why an item has failed its evaluation (i.e., for denoting why evaluation of an item 916 has a “FAILED” status). As shown in GUI 900, the rationale field 924 may be a drop down list that a user may interact with to display a list of pre-populated reasons or “exceptions” why the evaluation failed. For example, an item 916 may have failed because it was missing, broken, outside required operating parameters, and/or for any other suitable reason. These pre-populated rationales may be configured through the administrator interface 303 and the administrative application 302, as described herein. In alternative embodiments, the user conducting the analysis may be able to type in or input a custom rationale or “exception” for the failure. In some embodiments, entry or selection of a rational in the rational field 934 may automatically change the status of the item to “FAILED.”

In addition, GUI 900 illustrates a selectable field or icon 926 which, when selected by the user, may allow a user to enter text into GUI 900 and offer information about an item, such as a more detailed explanation of any of the evaluations of the various attributes 917. Further, GUI 900 illustrates a memo icon 928 that, when selected by a user, may cause the evaluation application 308 to display an overlaid text entry box, thereby allowing the user to enter additional observations about an item 916. GUI 900 also illustrates a finalize element 930 that, once the analysis of the object is completed, may be selected to generate a new interface for finalizing the analysis.

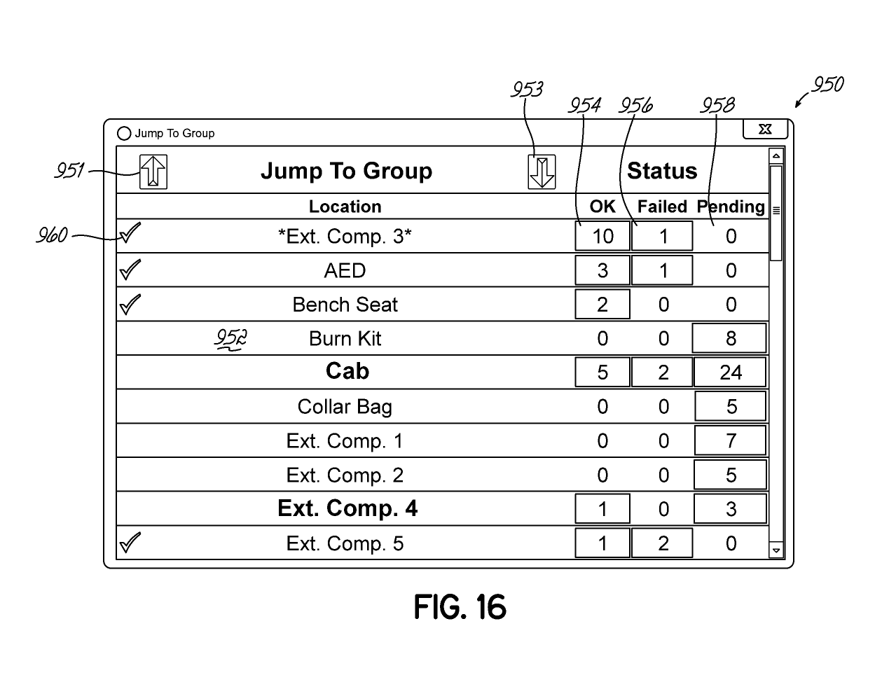

FIG. 16 illustrates an exemplary user interface or GUI 950 that may be generated by the evaluation application 308 in response to a user or evaluator electing to jump between groups of the procedure, such as by selecting jump element 932 (FIG. 15). GUI 950 illustrates a jump group display 952 listing the groups available for a user to jump to. The interface may include navigation elements, such as arrows 951 and 953, to traverse through the groups. The interface may also include indicators for each group indicating the current progress the group's evaluation. For example, GUI 950 illustrates fields 954, 956, and 958 that indicate how many items of each group have passed evaluation, failed evaluation, and remain to be evaluated, respectively. In some embodiments, field 954 indicates the number of passed items upon a green background, field 956 indicates the number of failed items upon a red background, and/or field 958 indicates the number of pending items in a yellow background. If the number listed in any of fields 954, 956, and/or 958 is zero, then the background applied to that field may be white. GUI 950 also illustrates an indicator for when all items of a group have been evaluated. For example, checkmark field 960 for each listed group displays a checkmark, preferably green, when no items of a give group are left pending or have yet to be evaluated.

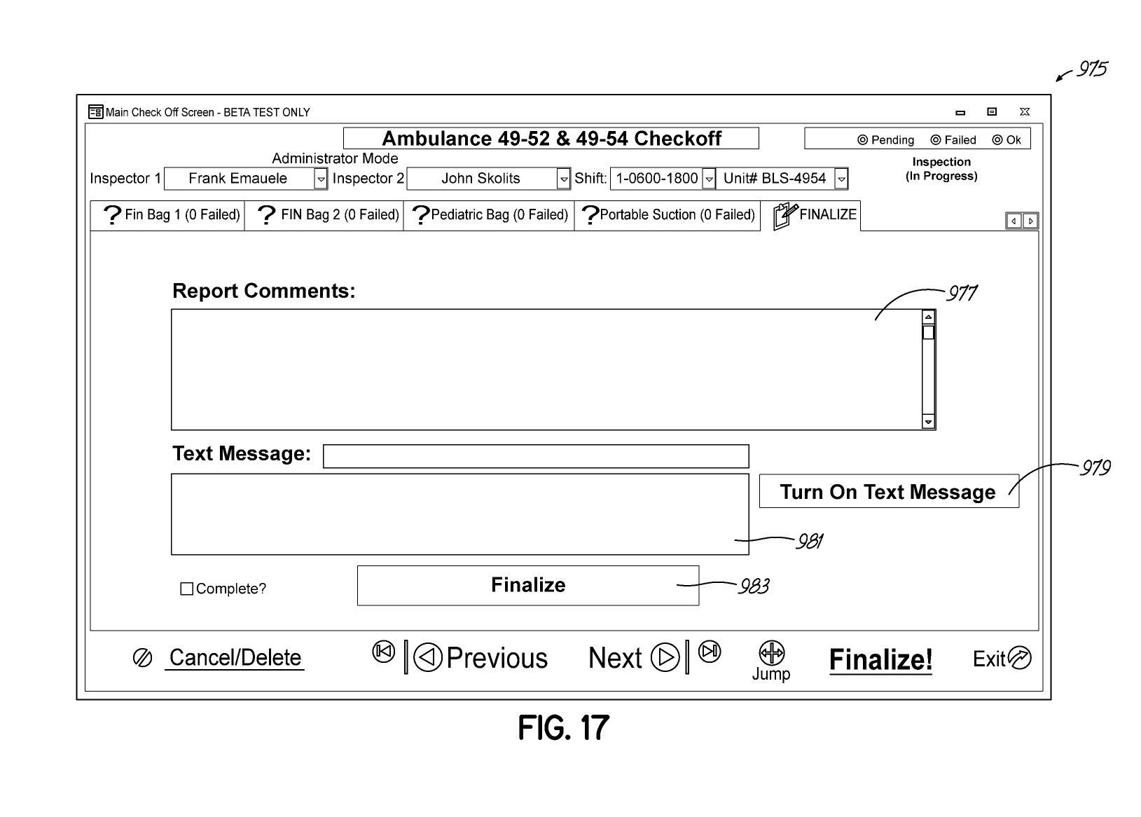

FIG. 17 illustrates an exemplary user interface or GUI 975 that may be generated by the evaluation application 308 in response to a user selecting to finalize an evaluation of an object, such as by selecting finalize element 930 (FIG. 15). GUI 975 enables a user to add any additional comments regarding the evaluation, such as through reporting field 977. GUI 977 also illustrates that an evaluator may enter a text message to be sent to recipients designated by the administrative application 302 for the downloaded procedure 306. For example, GUI 977 illustrates a text message enabling element 979. Upon the test message enabling element 979 being selected, a text message box 981 is enabled that allows a user to enter the text message. As described above, an evaluator may also indicate that the results or a report based thereon include replenishment values of one or more of the evaluation items. GUI 975 also illustrates a finalize element, such as finalize element 983, which, when selected, causes the results of the evaluation, which includes the additional information entered into the reporting field 977 and text message box 981, if any, and optionally the replenishment data, to be sent to the results database 310.

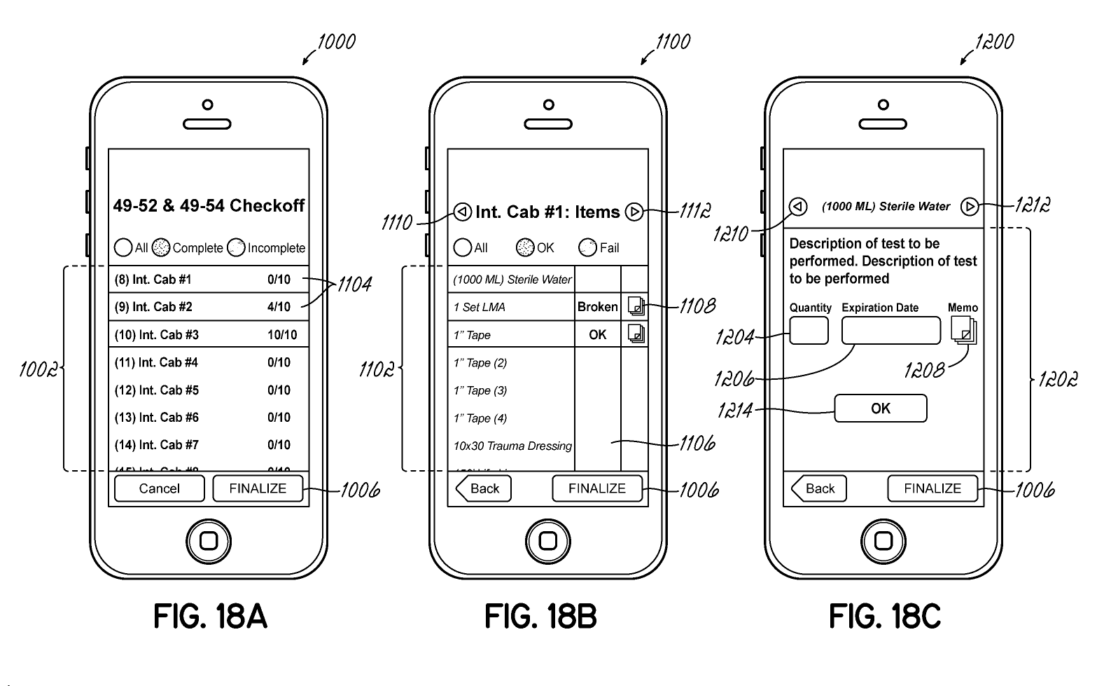

FIGS. 18A-18C provide exemplary alternative interfaces or GUI's 1000, 1100, and 1200 that may be generated by the evaluation application 308 of the invention in response to a user selecting a procedure 306 to analyze an object. In general, GUI's 1000, 1100, and/or 1200 may be implemented when a user's device running evaluation application 308 is smaller in size, such as a cellular phone device where a larger GUI 900 (FIG. 15) would be impractical.

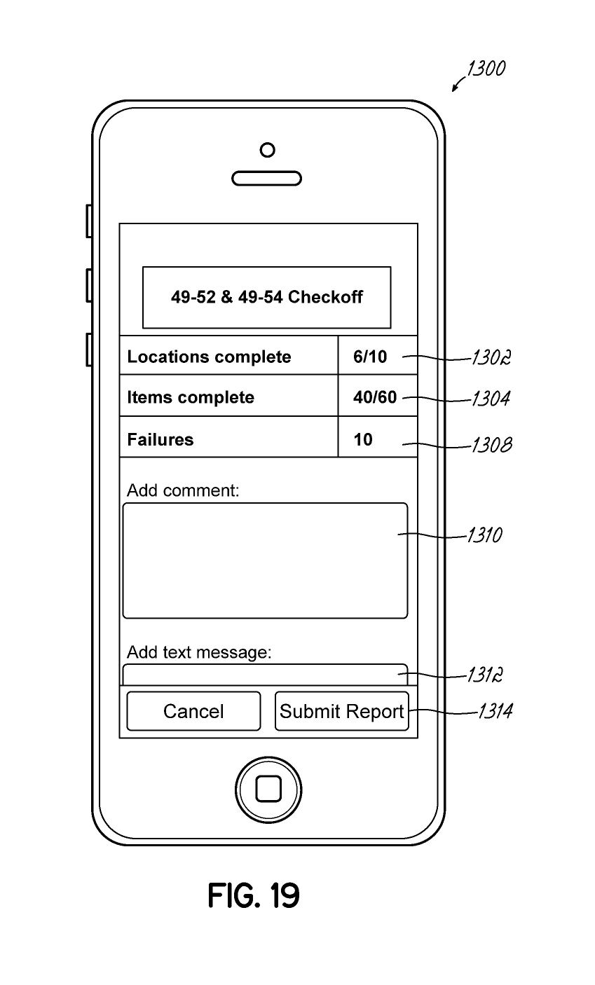

FIG. 18A provides an example illustration of a GUI 1000 that is generated by the evaluation application 308 for analyzing an object according to a downloaded procedure 306. GUI 1000 illustrates a list of various groups 1002 displayed according to the predetermined sequence associated with the downloaded checkoff procedure 306. Moreover, GUI 1000 illustrates a notification area 1004 for indicating how many items are in each group and out of those items how many items have been evaluated. By selecting one of the groups, the items associated with that group are displayed in the interface (FIG. 18B). As shown in GUI 1000, the background color or pattern of each group 1002 may vary depending on whether all, some, or none of the items in that group have been evaluated. Once the analysis of the object has finished, a user may select the FINALIZE field 1006 that is illustrated in GUI 1000. Thereafter, the evaluation application 308 may generate a new user interface for finalizing the analysis of the object (e.g., FIG. 19).

FIG. 18B provides an example illustration of a GUI 1100 that is generated by the evaluation application 308 in response to a user selecting one of the groups 1002 (FIG. 18A). GUI 1100 generally illustrates the list of items 1102 of the selected group 1002, listed in order according to the predetermined sequence of the downloaded checkoff procedure 306. As discussed above, such a display encourages a particular order of the analysis. To this end, GUI 1100 additionally illustrates group navigation elements 1110 and 1112 for consecutively advancing between consecutive groups, which further encourages a user to analyze an object according to the predetermined sequence applied to the downloaded procedure 306, but provides the flexibility to move between groups randomly. GUI 1100 also illustrates fields that show the evaluation results associated with some of the attributes associated with each item. As illustrated in GUI 1100, for example, these fields may include a status field 1106 that indicates whether the item has failed or passed evaluation. If the item 1102 has failed, status field 1106 may also indicate the reason why evaluation of the item 1102 has failed, such as because the item 1102 is missing or broken. Moreover, as illustrated in GUI 1100, the background of the listed items 1102 may vary in color or pattern depending on whether it has been evaluated, has passed evaluation, and/or has failed evaluation. GUI 1100 also illustrates a memo field 1108, which a user may select to input any comments and/or observations about the item being evaluated. Once the checkoff procedure is completed, the user might engage the FINALIZE field 1006.

FIG. 18C provides an example illustration of a GUI 1200 that is generated by the evaluation application 308 for evaluating the attributes of an item 1102, such as when the item 1102 is selected in GUI 1100 (FIG. 18B). GUI 1200 illustrates several interactive elements for analyzing the attributes 1202 associated with the selected item 1102. As shown in GUI 1200, the elements may include status element 1214 for denoting whether evaluation of the item 1102 has passed (i.e., “ok”), failed, or is pending. Further, if the evaluation of item 1102 has failed, the status element 1214 may be interacted with so as to denote the reason for the failure, similar to that as described in reference to FIG. 15. In some embodiments, every time the user selects the status element 1214, the denoted status may change. Alternatively, in other embodiments, selecting the status element 1214 may cause a list of selectable statuses to display, and the user may make an appropriate selection therefrom.

GUI 1200 also illustrates other attributes, including a value type field 1204 and an expiration date field 1206 for inputting the appropriate value and expiration date of the selected item 1102, respectively. In preferred embodiments, only characters and/or numerals consistent with the attribute being evaluated may be entered within fields 1204 and 1206, as described with reference to FIG. 15. GUI 1200 additionally illustrates a field 1208 which, when selected by the user, allows a user to enter text to offer a more detailed explanation of any of the evaluations of the noted attributes. Moreover, GUI 1200 illustrates item navigation elements 1210 and 1212 for consecutively advancing between consecutive items 1102, thereby encouraging a user to evaluate each item 1102 according to the predetermined sequence associated with the downloaded procedure 306, but providing the flexibility to move between items randomly. Once the attributes for an item are addressed, the user can engage the FINALIZE field 1006.

FIG. 19 provides an example illustration of a GUI 1300 that may be generated by the evaluation application 308 in response to a user selecting FINALIZE field 1006 (FIGS. 18A-18C). GUI 1300, for example, illustrates summary indicators that relay information about the analysis. For example, as shown in GUI 1300, summary indicator 1302 displays the number of groups that have been completely evaluated for the checkoff procedure. Summary indicator 1304 displays the number of items that have been completely evaluated. Summary indicator 1308 may indicate the number of evaluated items that failed. Moreover, GUI 1300 illustrates a comment field 1310 and a test message field 1312, with which a user can interact to provide comments and/or other messages relating to the analysis. Any comments and/or messages provided by the user may be sent to the recipients designated in the downloaded procedure 306, as specified by the administrative application 302. As previously described, the interface may also include an option to view or cause to be included in the results or a report based thereon the item replenishment data. GUI 1300 further illustrates a submit report field 1314 that, when selected by a user, causes the results 312 of the analysis to be uploaded to the results database 310.

Once results 312 are uploaded and stored in results database 310, the communication application 316 may be configured to communicate a report based on the results 312 to designated recipients, which are specified by the administrative application 302 and stored as part of the procedure 306 in the procedure database 304. To this end, the communication application 316 may be configured to access, from the procedure database 304, the specific checkoff procedure 306 corresponding to the results 312 that is the subject of a report. By doing so, the communication application 316 may identify the appropriate designated recipients, and then communicate the reports to them accordingly. Preferably, the reporting application is configured to send reports by E-mail.

The program code embodying any of the embodiments of the invention described herein is capable of being individually or collectively distributed as a program product in a variety of different forms. In particular, the program code may be distributed using a computer readable media, which may include computer readable storage media and communication media. Computer readable storage media, which are inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Communication media may embody computer readable instructions, data structures, or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

The methods described herein can be implemented by computer program instructions supplied to the processor of any type of computer to produce a machine with a processor that executes the instructions to implement the functions/acts specified herein. These computer program instructions may also be stored in a computer readable medium that can direct a computer to function in a particular manner. To that end, the computer program instructions may be loaded onto a computer to cause the performance of a series of operational steps and thereby produce a computer implemented process such that the executed instructions provide processes for implementing the functions/acts specified herein.

In addition, program code described herein may be identified based upon the application or software component within which the program code is implemented in a specific embodiment of the invention. However, it should be appreciated that any particular program nomenclature that follows is used merely for convenience, and thus the invention should not be limited to use solely in any specific application identified and/or implied by such nomenclature. It should be further appreciated that the various features, applications, and devices disclosed herein may also be used alone or in any combination. Moreover, given the typically endless number of manners in which computer programs may be organized into routines, procedures, methods, modules, objects, and the like, as well as the various manners in which program functionality may be allocated among various software layers that are resident within a typical computing system (e.g., operating systems, libraries, APIs, applications, applets, etc.), and/or across one or more hardware platforms, it should be appreciated that the invention is not limited to the specific organization and allocation of program functionality described herein.

While embodiments of the invention have been illustrated by a description of various examples, and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

What is claimed is:

1. A method for analyzing an object to determine contents of the object, the method comprising:
defining a plurality of groups that segment the object to be analyzed;
assigning one or more separate items to each group of the defined plurality of groups;
associating, with each item, one or more attributes for the item;
defining a predefined sequence for evaluation of the items and attributes;
displaying the items in the predefined sequence on a device for evaluation of the items and attributes associated with each item; and
presenting an attribute field associated with each attribute for each item, the attribute field being configured to be electronically interacted with to indicate an evaluation of the attribute.

2. The method of claim 1, wherein at least one of the attributes for an item is a status of the item including at least one of an OK status, a pending status, or a failed status.

3. The method of claim 2, further comprising:
designating a plurality of potential exceptions relating to the failed status of the item.

4. The method of claim 1, wherein at least one of the attributes for an item includes a value type attribute associated with the item.

5. The method of claim 4, wherein at least one of the attributes includes a logic test, the logic test configured to evaluate the value type attribute associated with the item.

6. The method of claim 1, further comprising:
presenting a text field associated with one of the items, the text field configured to be electronically interacted with to provide additional information about the evaluation of at least one of the attributes of the item.

7. The method of claim 1, further comprising:
assigning each item to a category that is descriptive of the item; and
displaying the items by category to a user to facilitate assigning the one or more items to the defined groups.

8. The method of claim 1, further comprising:
designating an allowable input type for the attribute field associated with at least one of the attributes for an item.

9. The method of claim 1, further comprising:
designating an alternate name for each item; and
displaying different names for the items on different devices.

10. The method of claim 1, further comprising:
generating a report of an analysis of an object; and
providing the report to a recipient via a text message or an E-mail.

11. A system for analyzing an object to determine contents of the object comprising:
a processor; and
a memory coupled to the processor, the memory storing instructions that, when executed by the processor, cause the system to:
create a procedure that defines a plurality of groups that segment the object to be analyzed;
assign one or more separate items to each group of the defined plurality of groups;
associate, with each item, one or more attributes for the item;
define a predefined sequence for evaluation of the items and attributes; and
upload the procedure to a database accessible by a computing device over a communications network,
wherein the procedure, when downloaded by the computing device over the communications network, causes the computing device to:
display the items in the predefined sequence on the device for evaluation of the items and the attributes associated with each item; and
present an attribute field associated with each attribute for each item, the attribute field being configured to be electronically interacted with to indicate an evaluation of the attribute.

12. The system of claim 11, wherein at least one of the attributes for an item is a status of the item including at least one of an OK status, a pending status, or a failed status.

13. The system of claim 12, wherein the instructions further cause the system to designate a plurality of potential exceptions relating to the failed status of the item.

14. The system of claim 11, wherein at least one of the attributes further includes a value type associated with the item.

15. The system of claim 14, wherein at least one of the attributes includes a logic test configured to evaluate the value type attribute associated with the item.

16. The system of claim 11, wherein the computer device presents, in response to a user input, a text field associated with one of the items, the text field configured to be electronically interacted with to provide additional information about an evaluation of at least one of the attributes of the item.

17. The system of claim 11, wherein the instructions further cause the system to:
assign each item to a category descriptive of the item; and
display the items by category to facilitate assigning the items to the groups.

18. The system of claim 11, wherein the instructions further cause the system to:
designate an allowable input for the attribute field associated with at least one of the attributes for an item.

19. The system of claim 11, wherein the instructions further cause the system to:
generate a report of an analysis of an object; and
provide the report to a recipient via a text message or an E-mail.

20. A computer program product comprising:
a non-transitory computer readable storage medium; and
program code stored on the computer readable storage medium and configured, upon execution by a processor, to cause the processor to:
create a procedure that defines a plurality of groups that segment the object to be analyzed;
assign one or more separate items to each group of the defined plurality of groups;
associate, with each item, one or more attributes for the item;
associate with the procedure a predefined sequence for evaluation of the items and attributes; and
upload the procedure to a database accessible by a computing device over a communications network,
wherein the procedure, when downloaded by the computing device over the communications network, causes the computing device to:
display the items in the predefined sequence for evaluation of the items and attributes associated with each item; and
present an attribute field associated with each attribute for each item, the attribute field being configured to be electronically interacted with to indicate an evaluation of the attribute.
